(19) United States
(12) Patent Application Publication
(10) Pub. No.: US 2024/0294419 A1
(43) Pub. Date: Sep. 5, 2024

(54) PHASE SEPARABLE GLASS COMPOSITIONS HAVING IMPROVED MECHANICAL DURABILITY

(71) Applicant: CORNING INCORPORATED, CORNING, NY (US)

(72) Inventors: John Philip Finkeldey, Elkland, PA (US); Charlene Marie Smith, Corning, NY (US)

(21) Appl. No.: 18/589,839

(22) Filed: Feb. 28, 2024

Related U.S. Application Data
(60) Provisional application No. 63/449,394, filed on Mar. 2, 2023.

(51) Int. Cl. C03C 3/093; C03C 3/091; C03C 3/095; C03C 3/097; C03C 21/00

(52) U.S. Cl. CPC C03C 3/093; C03C 3/091; C03C 3/095; C03C 3/097; C03C 21/002

(57) ABSTRACT

A glass composition includes: greater than or equal to 45 mol % and less than or equal to 70 mol % SiO₂; greater than or equal to 5 mol % and less than or equal to 15 mol % Al₂O₃; greater than or equal to 5 mol % and less than or equal to 15 mol % B₂O₃; greater than or equal to 5.5 mol % and less than or equal to 15 mol % Li₂O; and greater than or equal to 0.5 mol % and less than or equal to 12 mol % MgO. RO may be greater than or equal 5.5 mol % and less than or equal to 14 mol %, wherein RO is the sum of MgO, CaO, BaO, and SrO. The glass composition may be free of at least one of La₂O₃ and Yb₂O₃. The glass composition may be phase separable.

This application claims the benefit of priority under 35 U.S.C. § 119 of U.S. Provisional Application Ser. No. 63/449,394 filed on Mar. 2, 2023, the content of which is relied upon and incorporated herein by reference in its entirety.

### FIELD

The present specification generally relates to ion exchangeable glass compositions and, in particular, to ion exchangeable glass compositions capable of phase separation and having improved mechanical durability.

### TECHNICAL BACKGROUND

Glass articles, such as cover glasses, glass backplanes, and the like, are employed in both consumer and commercial electronic devices such as LCD and LED displays, computer monitors, automated teller machines (ATMs), and the like. Some of these glass articles may include “touch” functionality which necessitates that the glass article be contacted by various objects including a user's fingers and/or stylus devices and, as such, the glass must be sufficiently robust to endure regular contact without damage, such as scratching. Indeed, scratches introduced into the surface of the glass article may reduce the strength of the glass article as the scratches may serve as initiation points for cracks leading to catastrophic failure of the glass.

Moreover, the glass articles may also be incorporated in portable electronic devices, such as mobile telephones, personal media players, laptop computers, and tablet computers. Therefore, the optical characteristics of the glass article, such as the transmission of the glass article, may be an important consideration.

Accordingly, a need exists for alternative glasses which have improved mechanical properties while also having a relatively high transmission.

### SUMMARY

According to a first aspect A1, a glass composition may comprise: greater than or equal to 45 mol % and less than or equal to 70 mol % SiO₂; greater than or equal to 5 mol % and less than or equal to 15 mol % Al₂O₃; greater than or equal to 5 mol % and less than or equal to 15 mol % B₂O₃; greater than or equal to 5.5 mol % and less than or equal to 15 mol % Li₂O; and greater than or equal to 0.5 mol % and less than or equal to 12 mol % MgO, wherein RO is greater than or equal 5.5 mol % and less than or equal to 14 mol %, wherein RO is the sum of MgO, CaO, BaO, and SrO, the glass composition is free of at least one of La₂O₃ and Yb₂O₃, and the glass composition is phase separable.

A second aspect A2 includes the glass composition according to the first aspect A1, wherein the glass composition comprises greater than or equal to 5.5 mol % and less than or equal to 14 mol % B₂O₃.

A third aspect A3 includes the glass composition according to the first aspect A1 or the second aspect A2, wherein RO is greater than or equal to 6 mol % and less than or equal to 13 mol % RO.

A fourth aspect A4 includes the glass composition according to any one of the first through third aspects A1-A3, wherein B₂O₃+RO is greater than or equal to 10.5 mol % and less than or equal to 29 mol %.

A fifth aspect A5 includes the glass composition according to any one of the first through fourth aspects A1-A4, wherein the glass composition comprises greater than or equal to 1 mol % and less than or equal to 10 mol % MgO.

A sixth aspect A6 includes the glass composition according to any one of the first through fifth aspects A1-A5, wherein the glass composition comprises greater than or equal to 6 mol % and less than or equal to 14 mol % Li₂O.

A seventh aspect A7 includes the glass composition according to any one of the first through sixth aspects A1-A6, wherein the glass composition comprises greater than 0 mol % and less than or equal to 3 mol % Na₂O.

An eighth aspect A8 includes the glass composition according to any one of the first through seventh aspects A1-A7, wherein the glass composition comprises greater than 0 mol % and less than or equal to 2 mol % K₂O.

A ninth aspect A9 includes the glass composition according to any one of the first through eighth aspects A1-A8, wherein R₂O is greater than or equal to 5.5 mol % and less than or equal to 20 mol %, wherein R₂O is the sum of Li₂O, Na₂O, and K₂O.

A tenth aspect A10 includes the glass composition according to any one of the first through ninth aspects A1-A9, wherein the glass composition comprises greater than or equal to 5.5 mol % and less than or equal to 14 mol % Al₂O₃.

An eleventh aspect A11 includes the glass composition according to any one of the first through tenth aspects A1-A10, wherein the glass composition comprises greater than 0 mol % and less than or equal to 10 mol % CaO.

A twelfth aspect A12 includes the glass composition according to any one of the first through eleventh aspects A1-A11, wherein the glass composition comprises greater than 0 mol % and less than or equal to 5 mol % BaO.

A thirteenth aspect A13 includes the glass composition according to any one of the first through twelfth aspects A1-A12, wherein the glass composition comprises greater than 0 mol % and less than or equal to 2 mol % SrO.

A fourteenth aspect A14 includes the glass composition according to any one of the first through thirteenth aspects A1-A13, wherein ZrO₂+Y₂O₃+TiO₂ is greater than 0 mol % and less than or equal to 10 mol %.

A fifteenth aspect A15 includes the glass composition according to any one of the first through fourteenth aspects A1-A14, wherein the glass composition comprises greater than 0 mol % and less than or equal to 10 mol % ZrO₂.

A sixteenth aspect A16 includes the glass composition according to any one of the first through fifteenth aspects A1-A15, wherein the glass composition comprises greater than 0 mol % and less than or equal to 10 mol % Y₂O₃.

A seventeenth aspect A17 includes the glass composition according to any one of the first through sixteenth aspects A1-A16, wherein the glass composition comprises greater than 0 mol % and less than or equal to 10 mol % TiO₂.

An eighteenth aspect A18 includes the glass composition according to any one of the first through seventeenth aspects A1-A17, wherein R₂O/Al₂O₃ is greater than or equal to 0.25 and less than or equal to 2.5, wherein R₂O is the sum of Li₂O, Na₂O, and K₂O.

A nineteenth aspect A19 includes the glass composition according to any one of the first through eighteenth aspects A1-A18, wherein R₂O—Al₂O₃ is greater than or equal to −3 mol % and less than or equal to 8 mol %, wherein R₂O is the sum of Li₂O, Na₂O, and K₂O.

A twentieth aspect A20 includes the glass composition according to any one of the first through nineteenth aspects A1-A19, wherein B₂O₃/Al₂O₃ is greater than or equal to 0.25 and less than or equal to 2.

A twenty-first aspect A21 includes the glass composition according to any one of the first through twentieth aspects A1-A20, wherein (R₂O—Al₂O₃)—B₂O₃ is greater than or equal to −16 mol % and less than or equal to −1 mol %, wherein R₂O is the sum of Li₂O, Na₂O, and K₂O.

A twenty-second aspect A22 includes the glass composition according to any one of the first through twenty-first aspects A1-A21, wherein RO—B₂O₃ is greater than or equal to −7 mol % and less than or equal to 7 mol %.

A twenty-third aspect A23 includes the glass composition according to any one of the first through twenty-second aspects A1-A22, wherein (RO—Al₂O₃)—B₂O₃ is greater than or equal to −12 mol % and less than or equal to 10 mol %.

A twenty-fourth aspect A24 includes the glass composition according to any one of the first through twenty-third aspects A1-A23, wherein Li₂O/R₂O is greater than or equal to 0.2 and less than or equal to 1, wherein R₂O is the sum of Li₂O, Na₂O, and K₂O.

According to a twenty-fifth aspect A25, a multi-phase glass may comprise: greater than or equal to 45 mol % and less than or equal to 70 mol % SiO₂; greater than or equal to 5 mol % and less than or equal to 15 mol % Al₂O₃; greater than or equal to 5 mol % and less than or equal to 15 mol % B₂O₃; greater than or equal to 5.5 mol % and less than or equal to 15 mol % Li₂O; and greater than or equal to 0.5 mol % and less than or equal to 12 mol % MgO, wherein RO is greater than or equal 5.5 mol % and less than or equal to 14 mol %, wherein RO is the sum of MgO, CaO, BaO, and SrO, the multi-phase glass is free of at least one of La₂O₃ and Yb₂O₃; and the multi-phase glass comprises at least two phases.

A twenty-sixth aspect A26 includes the multi-phase glass according to the twenty-fifth aspect A25, wherein the at least two phases of the multi-phase glass comprises at least two glass phases.

A twenty-seventh aspect A27 includes the multi-phase glass according to the twenty-fifth aspect A25 or the twenty-sixth aspect A26, wherein an average transmittance of the multi-phase glass is greater than or equal to 88% over the wavelength range of 400 nm to 800 nm, as measured at an article thickness of 0.8 mm.

A twenty-eight aspect A28 includes the multi-phase glass according to any one of the twenty-fifth through twenty-seventh aspects A25-A27, wherein the multi-phase glass comprises a Young's modulus greater than or equal to 70 GPa.

A twenty-ninth aspect A29 includes the multi-phase glass according to any one of the twenty-fifth through twenty-eighth aspects A25-A28, wherein the multi-phase glass comprises a K_{IC} fracture toughness greater than or equal to 0.70 MPa·m^{1/2}, as measured by a chevron notch short bar method.

A thirtieth aspect A30 includes the multi-phase glass according to any one of the twenty-fifth through twenty-ninth aspects A25-A29, wherein the multi-phase glass is an ion exchanged multi-phase glass having a thickness t, a peak surface compressive stress greater than or equal to 450 MPa, a depth of layer greater than or equal to 3 μm, a depth of compression greater than or equal to 0.1t, and a maximum central tension greater than or equal to 50 MPa, as measured at an article thickness of 0.8 mm.

According to a thirty-first aspect A31, a method of forming a multi-phase glass may comprise: heating a glass composition, the glass composition comprising: greater than or equal to 45 mol % and less than or equal to 70 mol % SiO₂; greater than or equal to 5 mol % and less than or equal to 15 mol % Al₂O₃; greater than or equal to 5 mol % and less than or equal to 15 mol % B₂O₃; greater than or equal to 5.5 mol % and less than or equal to 15 mol % Li₂O; and greater than or equal to 0.5 mol % and less than or equal to 12 mol % MgO, wherein RO is greater than or equal 5.5 mol % and less than or equal to 14 mol %, wherein RO is the sum of MgO, CaO, BaO, and SrO, and the glass composition is free of at least one of La₂O₃ and Yb₂O₃; and cooling the glass composition to form the multi-phase.

A thirty-second aspect A32 includes the method according to the thirty-first aspect A31, wherein during the cooling step, the glass composition undergoes spinodal decomposition.

A thirty-third aspect A33 includes the method according to the thirty-first aspect A31 or the thirty-second aspect A32, wherein further comprising strengthening the multi-phase glass in an ion exchange bath at a temperature greater than or equal to 350° C. to less than or equal to 550° C. for a time period greater than or equal to 2 hours to less than or equal to 24 hours to form an ion exchanged multi-phase glass.

A thirty-fourth aspect A34 includes the method according to the thirty-third aspect A33, wherein the ion exchanged multi-phase glass comprises a peak surface compressive stress greater than or equal to 450 MPa.

A thirty-fifth aspect A35 includes the method according to the thirty-third aspect A33 or the thirty-fourth aspect A34, wherein the ion exchanged multi-phase glass comprises a depth of layer greater than or equal to 3 μm.

A thirty-sixth aspect A36 includes the method according to the thirty-third through thirty-fifth aspects A33-A35, wherein the ion exchanged multi-phase glass comprises a thickness t and a depth of compression greater than or equal to 0.035t.

A thirty-seventh aspect A37 includes the method according to the thirty-third through thirty-sixth aspects A33-A36, wherein the ion exchanged multi-phase glass comprises a maximum central tension greater than or equal to 50 MPa, as measured at an article thickness of 0.8 mm.

A thirty-eighth aspect A38 includes the method according to the thirty-third through thirty-seventh aspects A33-A37, wherein the ion exchange bath comprises NaNO₃.

A thirty-ninth aspect A39 includes the method according to the thirty-third through thirty-eighth aspects A33-A38, wherein the ion exchange bath comprises KNO₃.

A fortieth aspect A40 includes the method according to the thirty-third through thirty-ninth aspects A33-A39, wherein a stored strain energy of the multi-phase glass is greater than or equal to 10 J/m².

A forty-first aspect A41 includes the method according to any one of the thirty-third through fortieth aspects A33-A40, wherein a stored strain energy of the multi-phase glass is greater than or equal to 32 J/m² and the multi-phase glass is non-frangible.

According to a forty-second aspect A42, a consumer electronic device comprises a housing having a front surface, a back surface, and side surfaces; and electrical components provided at least partially within the housing, the electrical components including at least a controller, a memory, and a display, the display being provided at or adjacent the front surface of the housing; wherein the display includes the multi-phase class of any one of the twenty-fifth through thirtieth aspects A25-A30.

Additional features and advantages of the glass compositions and the resultant multi-phase glasses described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a representation of a non-frangible sample after a frangibility test;

FIG. 2 is a representation of a frangible sample after a frangibility test;

FIG. 3 is a plan view of an electronic device incorporating any of the multi-phase glasses, according to one or more embodiments described herein;

FIG. 4 is a perspective view of the electronic device of FIG. 3;

FIG. 5 is a scanning electron microscope (SEM) image at a magnification of 25 times of a multi-phase glass made from a glass composition, according to one or more embodiments described herein;

FIG. 6 is an SEM image of the multi-phase glass of FIG. 5 at a magnification of 50 times;

FIG. 7 is a plot of time (x-axis; in hours) versus central tension (y-axis; in MPa) of multi-phase glasses made from glass compositions, according to one or more embodiments described herein;

FIG. 8 is a plot of time (x-axis; in hours) versus central tension (y-axis; in MPa) of multi-phase glasses made from glass compositions, according to one or more embodiments described herein;

FIG. 9 is a plot of time (x-axis; in hours) versus central tension (y-axis; in MPa) and stored strain energy (y-axis; in J/m²) of multi-phase glasses made from glass compositions, according to one or more embodiments described herein;

FIG. 10 is a photograph of a multi-phase glass made from a glass composition and subjected to a frangibility test, according to one or more embodiments described herein;

FIG. 11 is a photograph of a multi-phase glass made from a glass composition and subjected to a frangibility test, according to one or more embodiments described herein;

FIG. 12 is a photograph of a multi-phase glass made from a glass composition and subjected to a frangibility test, according to one or more embodiments described herein;

FIG. 13 is a photograph of a multi-phase glass made from a glass composition and subjected to a frangibility test, according to one or more embodiments described herein; and

FIG. 14 is a plot of time (x-axis; in hours) versus central tension (y-axis; in MPa) of multi-phase glasses made from glass compositions, according to one or more embodiments described herein.

### DETAILED DESCRIPTION

Reference will now be made in detail to various embodiments of phase separable glass compositions having improved mechanical durability. According to embodiments, a glass composition includes: greater than or equal to 45 mol % and less than or equal to 70 mol % SiO₂; greater than or equal to 5 mol % and less than or equal to 15 mol % Al₂O₃; greater than or equal to 5 mol % and less than or equal to 15 mol % B₂O₃; greater than or equal to 5.5 mol % and less than or equal to 15 mol % Li₂O; and greater than or equal to 0.5 mol % and less than or equal to 12 mol % MgO. RO may be greater than or equal 5.5 mol % and less than or equal to 14 mol %, wherein RO is the sum of MgO, CaO, BaO, and SrO. The glass composition may be free of at least one of La₂O₃ and Yb₂O₃. The glass composition may be phase separable. Various embodiments of phase separable glass compositions and methods of making multi-phase glasses will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions and resultant multi-phase glasses described herein, the concentrations of constituent components (e.g., SiO₂, Al₂O₃, and the like) are specified in mole percent (mol %) on an oxide basis, unless otherwise specified.

The term “substantially free,” when used to describe the concentration and/or absence of a particular constituent component in a glass composition and the resultant multi-phase glass, means that the constituent component is not intentionally added to the glass composition and the multi-phase glass. However, the glass composition and the resultant multi-phase glass may contain traces of the constituent component as a contaminant or tramp in amounts of less than 0.1 weight percent (wt %). As noted herein, the remainder of the application specifies the concentrations of constituent component in mol %. The contaminant or tramp amounts of the constituent components are listed in wt % for manufacturing purposes and one skilled in the art would understand the contaminant and tramp amounts being listed in wt %.

The terms “0 mol %” and “free,” when used to describe the concentration and/or absence of a particular constituent component in a glass composition and the resultant multi-phase glass, means that the constituent component is not present in the glass composition and the resultant multi-phase glass.

The term “fracture toughness,” as used herein, refers to the K_{Ic} value, and is measured by the chevron notched short bar method. The chevron notched short bar (CNSB) method is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992).

The term “average transmission,” as used herein, refers to the average of transmission made within a given wavelength range with each wavelength weighted equally. In the embodiments described herein, the “average transmission” is reported over the wavelength range from 400 nm to 800 nm (inclusive of endpoints).

The term “transparent,” when used to describe a multi-phase glass formed of a glass composition herein, means that the multi-phase glass has an average transmission of greater than or equal to 88% when measured at normal incidence for light in a wavelength range from 400 nm to 800 nm (inclusive of endpoints) at an article thickness of 0.8 mm.

The viscosity of the glass composition, as described herein, is measured according to ASTM C965-96.

The term “melting point,” as used herein, refers to the temperature at which the viscosity of the glass composition is 200 poise.

The term “softening point,” as used herein, refers to the temperature at which the viscosity of the glass composition is 1×10^{7.6} poise.

The term “strain point,” as used herein, refers to the temperature at which the viscosity of the glass composition is 1×10^{14.68} poise.

The term “liquidus viscosity,” as used herein, refers to the viscosity of the glass composition at the onset of devitrification (i.e., at the liquidus temperature as determined with the gradient furnace method according to ASTM C829-81).

Density, as described herein, is measured by the buoyancy method of ASTM C693-93.

The elastic modulus (also referred to as Young's modulus) of the multi-phase glass, as described herein, is provided in units of gigapascals (GPa) and is measured in accordance with ASTM C623.

Shear modulus of the multi-phase glass, as described herein, is provided in units of gigapascals (GPa). The shear modulus of the multi-phase glass is measured in accordance with ASTM C623.

Poisson's ratio, as described herein, is measured in accordance with ASTM C623.

Refractive index, as described herein, is measured in accordance with ASTM E1967.

As used herein, “peak compressive stress” refers to the highest compressive stress (CS) value measured within a compressive stress region. In aspects, the peak compressive stress is located at the surface of the multi-phase glass. In other aspects, the peak compressive stress may occur at a depth below the surface, giving the compressive stress profile the appearance of a “buried peak.” Unless specified otherwise, compressive stress (including surface CS) is measured by surface stress meter (FSM) using commercially available instruments, for example, the FSM-6000, manufactured by Orihara Industrial Co., Ltd. (Japan). Surface stress measurements rely upon the accurate measurement of the stress optical coefficient (SOC) which is related to the birefringence as a function of imposed compression of the multi-phase glass. SOC in turn is measured according to Procedure C (Glass Disk Method) described in ASTM C770-16, entitled “Standard Test Method for measurement of Glass Stress-Optical Coefficient.” The maximum central tension (CT) values are measured using a Scattered Light Polariscope (SCALP), such as a SCALP-05 portable scattered light polariscope. The values reports for central tension (CT) herein refer to the maximum central tension, unless otherwise indicated.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the multi-phase glass. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety.

According to the convention normally used in the art, compression or compressive stress (CS) is expressed as a negative (i.e., <0) stress and tension or tensile stress is expressed as a positive (i.e., >0) stress. Throughout this description, however, CS is expressed as a positive or absolute value (i.e., as recited herein, CS=|CS|).

As used herein, “depth of compression” (DOC) refers to the depth at which the stress within the multi-phase glass changes from compressive to tensile. At the DOC, the stress crosses from a compressive stress to a tensile stress and thus exhibits a stress value of zero. Depth of compression may be measured using a Scattered Light Polariscope (SCALP), such as a SCALP-05 portable scattered light polariscope. As used herein, “depth of layer” (DOL) refers to the depth within a multi-phase glass at which an ion of metal oxide diffuses into the multi-phase glass where the concentration of the ion reaches a minimum value. DOL may be measured using electron probe microanalysis (EPMA).

The stored strain energy Σ₀, as described herein, may be calculated according to the following equation (I):

$${Σ}_{0} = \frac{1 - v}{2 E} {\int }_{- {z}^{*}}^{+ {z}^{*}} ( {σ}_{x}^{2} + {σ}_{y}^{2} ) dz = \frac{1 - v}{2 E} {\int }_{- {z}^{*}}^{+ {z}^{*}} ( 2 {σ}^{2} ) dz \qquad ( I )$$

wherein z*=0.5t−δ, t is the thickness of the multi-phase glass, δ is the depth of compression, v is Poisson's ratio, E is Young's modulus (in MPa), and σ is stress contained in the tensile zone (in MPa). The integration is computed across the thickness (in micrometers) of the tensile region only.

As used herein, the “frangibility limit” refers to the central tension or stored strain energy above which the multi-phase glass exhibits frangible behavior. “Frangibility” or “frangible behavior” refers to specific fracture behavior when a material is subjected to an impact or insult. As utilized herein, a multi-phase glass is considered non-frangible when it exhibits at least one of the following in a test area as a result of a frangibility test: (1) four or less fragments with a largest dimension of at least 1 mm, and/or (2) the number of bifurcations is less than or equal to the number of crack branches. The fragments, bifurcations, and crack branches are counted based on any 2 inch by 2 inch square centered on the impact point. Thus, a multi-phase glass is considered non-frangible if it meets one or both of tests (1) and (2) for any 2 inch by 2 inch square centered on the impact point where the breakage is created according to the procedure described below. In a frangibility test, an impact probe is brought in to contact with the multi-phase glass, with the depth to which the impact probe extends into the multi-phase glass increasing in successive contact iterations. The step-wise increase in depth of the impact probe allows the flaw produced by the impact probe to reach the tension region while preventing the application of excessive external force that would prevent the accurate determination of the frangible behavior of the multi-phase glass. In embodiments, the depth of the impact probe in the multi-phase glass may increase by about 5 μm in each iteration, with the impact probe being removed from contact with the multi-phase glass between each iteration. The test area is any 2 inch by 2 inch square centered at the impact point.

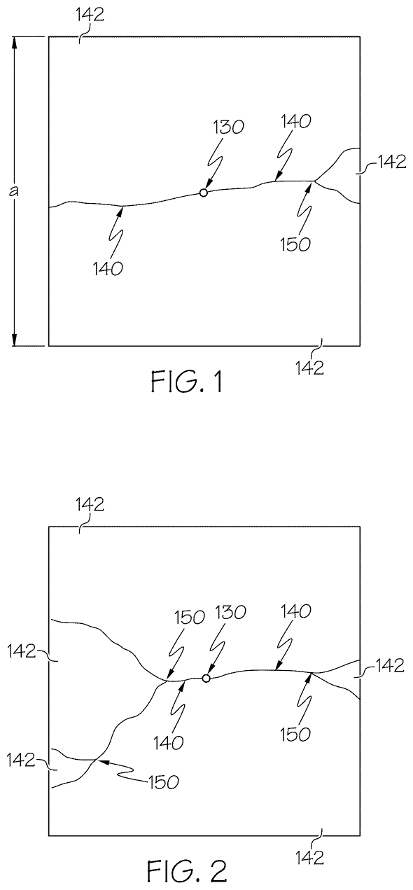

FIG. 1 depicts a non-frangible test result. As shown in FIG. 1, the test area is a square that is centered at the impact point 130, where the length of a side of the square a is 2 inches. The non-frangible sample shown in FIG. 1 includes three fragments 142, two crack branches 140, and a single bifurcation 150. Thus, the non-frangible sample shown in FIG. 1 contains less than four fragments having a largest dimension of at least 1 mm and the number of bifurcations is less than or equal to the number of crack branches. As utilized herein, a crack branch originates at the impact point, and a fragment is considered to be within the test area is any part of the fragment extends into the test area. While coatings, adhesive layers, and the like may be used in conjunction with the multi-phase glass described herein, such external restraints are not used in determining the frangibility or frangible behavior of the multi-phase glass. In embodiments, a film that does not affect the fracture behavior of the multi-phase glass may be applied to the multi-phase glass prior to the frangibility test to prevent the ejection of fragments from the multi-phase glass, increasing safety for the person performing the test.

A frangible sample is depicted in FIG. 2. The frangible sample includes five fragments 142 having crack branches 140 and three bifurcations 150, producing more bifurcations than crack branches. Thus, the sample depicted in FIG. 2 does not exhibit either four or less fragments or the number of bifurcations being less than or equal to the number of crack branches.

In the frangibility test described herein, the impact is delivered to the surface of the multi-phase glass with a force that is just sufficient to release the internally stored energy present within the strengthened multi-phase glass. That is, the point impact force is sufficient to create at least one new crack at the surface of the strengthened glass sheet and extend the crack through the compressive stress layer into the region that is under central tension (CT).

The phrase “phase separable,” as used herein, refers to a glass composition that forms a multi-phase glass having two or more distinct phases (i.e., having one or more compositions, amounts, morphologies, sizes or size distributions, etc.). Phase separation may induce spinodal decomposition or dispersed particles into at least two glass phases.

The phrase “spinodal decomposition,” as used herein, refers to a mechanism by which a single homogenous glass composition can separate uniformly into two or more distinct glass phases with an interconnected microstructure (i.e., having two or more compositions, amounts, morphologies, sizes or size distributions, etc.).

The phrase “dispersed particles,” as used herein, refers to a morphology by which a first glass phase is dispersed as particles (i.e., discrete islands) in a matrix of a second glass phase.

The phrase “spontaneously phase separable,” as used herein, refers to a glass composition that phase separates upon formation of the glass (i.e. upon cooling from the melt). In particular, a glass composition is “spontaneously phase separable” if a glass melt of the glass composition delivered onto a surface at viscosity less than 6000 poise and cooled to room temperature is phase separated.

The phrase “multi-phase glass,” as used herein, refers to a material or article formed from a phase separable glass composition and including at least two glass phases.

Chemical strengthening processes have been used to achieve high strength and high toughness in alkali silicate glasses. The frangibility limit of a chemically strengthened glass is generally controlled by the fracture toughness and/or the elastic modulus of the components of the glass. Silica has a relatively low K_{IC} fracture toughness of 0.7 MPa·m^{1/2}; silicate glasses having components with, for example, high field strength are known to have fracture toughness values greater than 0.7 MPa·m^{1/2}, but less than 1.0 MPa·m^{1/2}.

Phase separated glasses may help improve K_{IC} fracture toughness. Without wishing to be bound by theory, examples of mechanisms of phase separated glasses that result in improved K_{IC} fracture toughness may include a tortuous microstructure to deflect cracks, a coefficient of thermal expansion mismatch between the phases, and/or an elastic modulus mismatch between the phases. However, it may be difficult to achieve transparency in these materials as they are comprised of at least two dissimilar glass phases. The chemical compositions and hence the refractive indices of the glasses may be sufficiently different such that transparency is compromised. Furthermore, the physical scale of the phase separation should also be managed to ensure low scattering and high transparency. Moreover, phase separating a glass may require an extra heat treatment step.

Disclosed herein are glass compositions and multi-phase glasses which mitigate the aforementioned problems. Specifically, the glass compositions disclosed herein comprise a relatively high concentration of B₂O₃ and RO (i.e., MgO+CaO+BaO+SrO), which results in spontaneously phase separated glass compositions that form transparent multi-phase glasses having improved fracture toughness and Young's modulus. The glass compositions described herein are spontaneously phase separable and do not require an additional heat treatment step after formation of the glass to achieve phase separation.

The glass compositions and multi-phase glasses described herein may be described as aluminoborosilicate glass compositions and comprise SiO₂, Al₂O₃, B₂O₃, and RO (i.e., MgO+CaO+BaO+SrO). In addition to SiO₂, Al₂O₃, B₂O₃, and RO, the glass compositions and multi-phase glasses described herein also include alkali oxide, such as Li₂O, to enable the ion exchangeability of the glass compositions. The glass compositions described herein are also free of at least one of La₂O₃ and Yb₂O₃.

SiO₂ is the primary glass former in the glass compositions described herein and may function to stabilize the network structure of the multi-phase glasses. The concentration of SiO₂ in the glass compositions and the resultant multi-phase glasses should be sufficiently high (e.g., greater than or equal to 45 mol %) to enhance the chemical durability of the glass composition and, in particular, the resistance of the glass composition and the resulting multi-phase glass to degradation upon exposure to acidic solutions, basic solutions, and in water. The amount of SiO₂ may be limited (e.g., to less than or equal to 70 mol %) to control the melting point of the glass composition, as the melting temperature of pure SiO₂ or high-SiO₂ glasses is undesirably high. Thus, limiting the concentration of SiO₂ may aid in improving the meltability and the formability of the resultant multi-phase glass.

Accordingly, in embodiments, the glass composition and the resultant multi-phase glass may comprise greater than or equal to 45 mol % and less than or equal to 70 mol % SiO₂. In embodiments, the concentration of SiO₂ in the glass composition and the resultant multi-phase glass may be greater than or equal to 45 mol %, greater than or equal to 47 mol %, greater than or equal to 53 mol %, or even greater than or equal to 55 mol %. In embodiments, the concentration of SiO₂ in the glass composition and the resultant multi-phase glass may be less than or equal to 70 mol %, less than or equal to 67 mol %, less than or equal to 65 mol %, or even less than or equal to 63 mol %. In embodiments, the concentration of SiO₂ in the glass composition and the resultant multi-phase glass may be greater than or equal to 45 mol % and less than or equal to 70 mol %, greater than or equal to 45 mol % and less than or equal to 67 mol %, greater than or equal to 45 mol % and less than or equal to 65 mol %, greater than or equal to 45 mol % and less than or equal to 63 mol %, greater than or equal to 47 mol % and less than or equal to 70 mol %, greater than or equal to 47 mol % and less than or equal to 67 mol %, greater than or equal to 47 mol % and less than or equal to 65 mol %, greater than or equal to 47 mol % and less than or equal to 63 mol %, greater than or equal to 50 mol % and less than or equal to 70 mol %, greater than or equal to 50 mol % and less than or equal to 67 mol %, greater than or equal to 50 mol % and less than or equal to 65 mol %, greater than or equal to 50 mol % and less than or equal to 63 mol %, greater than or equal to 53 mol % and less than or equal to 70 mol %, greater than or equal to 53 mol % and less than or equal to 67 mol %, greater than or equal to 53 mol % and less than or equal to 65 mol %, greater than or equal to 53 mol % and less than or equal to 63 mol %, greater than or equal to 55 mol % and less than or equal to 70 mol %, greater than or equal to 55 mol % and less than or equal to 67 mol %, greater than or equal to 55 mol % and less than or equal to 65 mol %, or even greater than or equal to 55 mol % and less than or equal to 63 mol %, or any and all sub-ranges formed from any of these endpoints.

Like SiO₂, Al₂O₃ may also stabilize the glass network and additionally provides improved mechanical properties and chemical durability to the glass composition and the resultant multi-phase glass. The amount of Al₂O₃ may also be tailored to the control the viscosity and phase separation of the glass composition. The concentration of Al₂O₃ should be sufficiently high (e.g., greater than or equal to 5 mol %) to enable the development of multiple phases through phase separation. However, if the amount of Al₂O₃ is too high, the viscosity of the melt may increase diminishing the formability of the resultant multi-phase glass.

In embodiments, the glass composition and the resultant multi-phase glass may comprise greater than or equal to 5 mol % and less than or equal to 15 mol % Al₂O₃. In embodiments, the glass composition and the resultant multi-phase glass may comprise greater than or equal to 5.5 mol % and less than or equal to 14 mol % Al₂O₃. In embodiments, the concentration of Al₂O₃ in the glass composition and the resultant multi-phase glass may be greater than or equal to 5 mol %, greater than or equal to 5.5 mol %, greater than or equal to 6 mol %, greater than or equal to 6.5 mol %, or even greater than or equal to 7 mol %. In embodiments, the concentration of Al₂O₃ in the glass composition and the resultant multi-phase glass may be less than or equal 15 mol %, less than or equal to 14 mol %, less than or equal to 13 mol %, less than or equal to 12 mol %, less than or equal to 11 mol %, or even less than or equal to 10 mol %. In embodiments, the concentration of Al₂O₃ in the glass composition and the resultant multi-phase glass may be greater than or equal 5 mol % and less than or equal to 15 mol %, greater than or equal 5 mol % and less than or equal to 14 mol %, greater than or equal 5 mol % and less than or equal to 13 mol %, greater than or equal 5 mol % and less than or equal to 12 mol %, greater than or equal 5 mol % and less than or equal to 11 mol %, greater than or equal 5 mol % and less than or equal to 10 mol %, greater than or equal 5.5 mol % and less than or equal to 15 mol %, greater than or equal 5.5 mol % and less than or equal to 14 mol %, greater than or equal 5.5 mol % and less than or equal to 13 mol %, greater than or equal 5.5 mol % and less than or equal to 12 mol %, greater than or equal 5.5 mol % and less than or equal to 11 mol %, greater than or equal 5.5 mol % and less than or equal to 10 mol %, greater than or equal 6 mol % and less than or equal to 15 mol %, greater than or equal 6 mol % and less than or equal to 14 mol %, greater than or equal 6 mol % and less than or equal to 13 mol %, greater than or equal 6 mol % and less than or equal to 12 mol %, greater than or equal 6 mol % and less than or equal to 11 mol %, greater than or equal 6 mol % and less than or equal to 10 mol %, greater than or equal 6.5 mol % and less than or equal to 15 mol %, greater than or equal 6.5 mol % and less than or equal to 14 mol %, greater than or equal 6.5 mol % and less than or equal to 13 mol %, greater than or equal 6.5 mol % and less than or equal to 12 mol %, greater than or equal 6.5 mol % and less than or equal to 11 mol %, greater than or equal 6.5 mol % and less than or equal to 10 mol %, greater than or equal 7 mol % and less than or equal to 15 mol %, greater than or equal 7 mol % and less than or equal to 14 mol %, greater than or equal 7 mol % and less than or equal to 13 mol %, greater than or equal 7 mol % and less than or equal to 12 mol %, greater than or equal 7 mol % and less than or equal to 11 mol %, or even greater than or equal 7 mol % and less than or equal to 10 mol %, or any and all sub-ranges formed from any of these endpoints.

B₂O₃ decreases the melting temperature of the glass composition. B₂O₃ may also improve the damage resistance of the resultant multi-phase glass. In addition, B₂O₃ is added to reduce the formation of non-bridging oxygen, the presence of which may reduce fracture toughness. The concentration of B₂O₃ should be sufficiently high (e.g., greater than or equal to 5 mol %) to enable the development of multiple phases through phase separation. However, if B₂O₃ is too high, the chemical durability and liquidus viscosity may suffer and the evaporation during melting becomes difficult to control. Therefore, the amount of B₂O₃ may be limited (e.g., less than or equal to 15 mol %) to maintain chemical durability and manufacturability of the glass composition.

In embodiments, the glass composition and the resultant multi-phase glass may comprise greater than or equal to 5 mol % and less than or equal to 15 mol % B₂O₃. In embodiments, the glass composition and the resultant multi-phase glass may comprise greater than or equal to 5.5 mol % and less than or equal to 14.5 mol % B₂O₃. In embodiments, the concentration of B₂O₃ in the glass composition and the resultant multi-phase glass may be greater than or equal to 5 mol %, greater than or equal to 5.5 mol %, greater than or equal to 6 mol %, greater than or equal to 6.5 mol %, or even greater than or equal to 7 mol %. In embodiments, the concentration of B₂O₃ in the glass composition and the resultant multi-phase glass may be less than or equal to 15 mol %, less than or equal to 14 mol %, less than or equal to 13 mol %, less than or equal to 12 mol %, less than or equal to 11 mol %, or even less than or equal to 10 mol %. In embodiments the concentration of B₂O₃ in the glass composition and the resultant multi-phase glass may be greater than or equal 5 mol % and less than or equal to 15 mol %, greater than or equal 5 mol % and less than or equal to 14 mol %, greater than or equal 5 mol % and less than or equal to 13 mol %, greater than or equal 5 mol % and less than or equal to 12 mol %, greater than or equal 5 mol % and less than or equal to 11 mol %, greater than or equal 5 mol % and less than or equal to 10 mol %, greater than or equal 5.5 mol % and less than or equal to 15 mol %, greater than or equal 5.5 mol % and less than or equal to 14 mol %, greater than or equal 5.5 mol % and less than or equal to 13 mol %, greater than or equal 5.5 mol % and less than or equal to 12 mol %, greater than or equal 5.5 mol % and less than or equal to 11 mol %, greater than or equal 5.5 mol % and less than or equal to 10 mol %, greater than or equal 6 mol % and less than or equal to 15 mol %, greater than or equal 6 mol % and less than or equal to 14 mol %, greater than or equal 6 mol % and less than or equal to 13 mol %, greater than or equal 6 mol % and less than or equal to 12 mol %, greater than or equal 6 mol % and less than or equal to 11 mol %, greater than or equal 6 mol % and less than or equal to 10 mol %, greater than or equal 6.5 mol % and less than or equal to 15 mol %, greater than or equal 6.5 mol % and less than or equal to 14 mol %, greater than or equal 6.5 mol % and less than or equal to 13 mol %, greater than or equal 6.5 mol % and less than or equal to 12 mol %, greater than or equal 6.5 mol % and less than or equal to 11 mol %, greater than or equal 6.5 mol % and less than or equal to 10 mol %, greater than or equal 7 mol % and less than or equal to 15 mol %, greater than or equal 7 mol % and less than or equal to 14 mol %, greater than or equal 7 mol % and less than or equal to 13 mol %, greater than or equal 7 mol % and less than or equal to 12 mol %, greater than or equal 7 mol % and less than or equal to 11 mol %, or even greater than or equal 7 mol % and less than or equal to 10 mol %, or any and all sub-ranges formed from any of these endpoints.

In embodiments, the ratio of the concentration of B₂O₃ to the concentration of Al₂O₃ (i.e., B₂O₃ (mol %)/Al₂O₃ (mol %)) in the glass composition and the resultant multi-phase glass may be greater than or equal to 0.25 and less than or equal to 2. In embodiments, B₂O₃/Al₂O₃ in the glass composition and the resultant multi-phase glass may be greater than or equal to 0.25, greater than or equal to 0.5, or even greater than or equal to 0.75. In embodiments, B₂O₃/Al₂O₃ in the glass composition and the resultant multi-phase glass may be less than or equal to 2, less than or equal to 1.75, less than or equal to 1.5, or even less than or equal to 1.25. In embodiments, B₂O₃/Al₂O₃ in the glass composition and the resultant multi-phase glass may be greater than or equal to 0.25 and less than or equal to 2, greater than or equal to 0.25 and less than or equal to 1.75, greater than or equal to 0.25 and less than or equal to 1.5, greater than or equal to 0.25 and less than or equal to 1.25, greater than or equal to 0.5 and less than or equal to 2, greater than or equal to 0.5 and less than or equal to 1.75, greater than or equal to 0.5 and less than or equal to 1.5, greater than or equal to 0.5 and less than or equal to 1.25, greater than or equal to 0.75 and less than or equal to 2, greater than or equal to 0.75 and less than or equal to 1.75, greater than or equal to 0.75 and less than or equal to 1.5, or even greater than or equal to 0.75 and less than or equal to 1.25, or any and all sub-ranges formed from any of these endpoints.

As described hereinabove, the glass compositions may contain alkali oxide, such as Li₂O, to enable the ion exchangeability of the multi-phase glass. Li₂O aids in the ion exchangeability of the multi-phase glass and also reduces the softening point of the glass composition thereby increasing the formability of the glass. In embodiments, the glass composition and the resultant multi-phase glass may comprise greater than or equal to 5.5 mol % and less than or equal to 15 mol % Li₂O. In embodiments, the glass composition and the resultant multi-phase glass may comprise greater than or equal to 6 mol % and less than or equal to 14 mol % Li₂O. In embodiments, the concentration of Li₂O in the glass composition and the resultant multi-phase glass may be greater than or equal to 5.5 mol %, greater than or equal to 6 mol %, greater than or equal to 6.5 mol %, greater than or equal to 7 mol %, greater than or equal to 7.5 mol %, greater than or equal to 8 mol %, or even greater than or equal to 8.5 mol %. In embodiments, the concentration of Li₂O in the glass composition and the resultant multi-phase glass may be less than or equal to 15 mol %, less than or equal to 14 mol %, less than or equal to 13 mol %, less than or equal to 12 mol %, less than or equal to 11 mol %, or even less than or equal to 10 mol %. In embodiments, the concentration of Li₂O in the glass composition and the resultant multi-phase glass may be greater than or equal to 5.5 mol % and less than or equal to 15 mol %, greater than or equal to 5.5 mol % and less than or equal to 14 mol %, greater than or equal to 5.5 mol % and less than or equal to 13 mol %, greater than or equal to 5.5 mol % and less than or equal to 12 mol %, greater than or equal to 5.5 mol % and less than or equal to 11 mol %, greater than or equal to 5.5 mol % and less than or equal to 10 mol %, greater than or equal to 6 mol % and less than or equal to 15 mol %, greater than or equal to 6 mol % and less than or equal to 14 mol %, greater than or equal to 6 mol % and less than or equal to 13 mol %, greater than or equal to 6 mol % and less than or equal to 12 mol %, greater than or equal to 6 mol % and less than or equal to 11 mol %, greater than or equal to 6 mol % and less than or equal to 10 mol %, greater than or equal to 6.5 mol % and less than or equal to 15 mol %, greater than or equal to 6.5 mol % and less than or equal to 14 mol %, greater than or equal to 6.5 mol % and less than or equal to 13 mol %, greater than or equal to 6.5 mol % and less than or equal to 12 mol %, greater than or equal to 6.5 mol % and less than or equal to 11 mol %, greater than or equal to 6.5 mol % and less than or equal to 10 mol %, greater than or equal to 7 mol % and less than or equal to 15 mol %, greater than or equal to 7 mol % and less than or equal to 14 mol %, greater than or equal to 7 mol % and less than or equal to 13 mol %, greater than or equal to 7 mol % and less than or equal to 12 mol %, greater than or equal to 7 mol % and less than or equal to 11 mol %, greater than or equal to 7 mol % and less than or equal to 10 mol %, greater than or equal to 7.5 mol % and less than or equal to 15 mol %, greater than or equal to 7.5 mol % and less than or equal to 14 mol %, greater than or equal to 7.5 mol % and less than or equal to 13 mol %, greater than or equal to 7.5 mol % and less than or equal to 12 mol %, greater than or equal to 7.5 mol % and less than or equal to 11 mol %, greater than or equal to 7.5 mol % and less than or equal to 10 mol %, greater than or equal to 8 mol % and less than or equal to 15 mol %, greater than or equal to 8 mol % and less than or equal to 14 mol %, greater than or equal to 8 mol % and less than or equal to 13 mol %, greater than or equal to 8 mol % and less than or equal to 12 mol %, greater than or equal to 8 mol % and less than or equal to 11 mol %, or even greater than or equal to 8 mol % and less than or equal to 10 mol %, or any and all sub-ranges formed from any of these endpoints.

The glass compositions and resultant multi-phase glasses described herein may further comprise alkali metal oxides other than Li₂O, such as Na₂O and K₂O. In addition to aiding in ion exchangeability of the glass composition, Na₂O decreases the melting point and improves formability of the glass composition. However, if too much Na₂O is added to the glass composition, the melting point may be too low. In embodiments, the glass composition may comprise greater than 0 mol % and less than or equal to 3 mol % Na₂O. In embodiments, the concentration of Na₂O in the glass composition and the resultant multi-phase glass may be greater than or equal to 0 mol %, greater than or equal to 0.5 mol %, or even greater than or equal to 1 mol %. In embodiments, the concentration of Na₂O in the glass composition and the resultant multi-phase glass may be less than or equal to 3 mol %, less than or equal to 2.5 mol %, or even less than or equal to 2 mol %. In embodiments, the concentration of Na₂O in the glass composition and the resultant multi-phase glass may be greater than or equal to 0 mol % and less than or equal to 3 mol %, greater than or equal to 0 mol % and less than or equal to 2.5 mol %, greater than or equal to 0 mol % and less than or equal to 2 mol %, greater than or equal to 0.5 mol % and less than or equal to 3 mol %, greater than or equal to 0.5 mol % and less than or equal to 2.5 mol %, greater than or equal to 0.5 mol % and less than or equal to 2 mol %, greater than or equal to 1 mol % and less than or equal to 3 mol %, greater than or equal to 1 mol % and less than or equal to 2.5 mol %, or even greater than or equal to 1 mol % and less than or equal to 2 mol %, or any and all sub-ranges formed from any of these endpoints. In embodiments, the glass composition and the resultant multi-phase glass may be free or substantially free of Na₂O.

K₂O promotes ion exchange to increase the depth of compression and decreases the melting point to improve formability of the glass composition. However, adding K₂O may cause the surface compressive stress and melting point to be too low. In embodiments, the glass composition and the resultant multi-phase glass may comprise greater than 0 mol % and less than or equal to 2 mol % K₂O. In embodiments, the concentration of K₂O in the glass composition and the resultant multi-phase glass may be greater than or equal to 0 mol %, greater than or equal to 0.1 mol %, or even greater than or equal to 0.2 mol %. In embodiments, the concentration of K₂O in the glass composition and the resultant multi-phase glass may be less than or equal to 2 mol %, less than or equal to 1.5 mol %, less than or equal to 1 mol %, or even less than or equal to 0.5 mol %. In embodiments, the concentration of K₂O in the glass composition and the resultant multi-phase glass may be greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, greater than or equal to 0.1 mol % and less than or equal to 2 mol %, greater than or equal to 0.1 mol % and less than or equal to 1.5 mol %, greater than or equal to 0.1 mol % and less than or equal to 1 mol %, greater than or equal to 0.1 mol % and less than or equal to 0.5 mol %, greater than or equal to 0 mol % and less than or equal to 2 mol %, greater than or equal to 0.2 mol % and less than or equal to 1.5 mol %, greater than or equal to 0.2 mol % and less than or equal to 1 mol %, or even greater than or equal to 0.2 mol % and less than or equal to 0.5 mol %, or any and all sub-ranges formed from any of these endpoints. In embodiments, the glass composition and the resultant multi-phase glass may be free or substantially free of K₂O.

R₂O is the sum (in mol %) of Li₂O, Na₂O, and K₂O present in the glass composition and the resultant multi-phase glass (i.e., R₂O═Li₂O (mol %)+Na₂O (mol %)+K₂O (mol %)). Like B₂O₃, the alkali oxides aid in decreasing the softening point and molding temperature of the glass composition, thereby offsetting the increase in the softening point and molding temperature of the glass composition due to higher amounts of SiO₂ in the glass composition, for example. The softening point and molding temperature may be further reduced by including combinations of alkali oxides (e.g., two or more alkali oxides) in the glass composition, a phenomenon referred to as the “mixed alkali effect.” However, it has been found that if the amount of R₂O is too high, the average coefficient of thermal expansion of the glass composition increases to greater than 100×10⁻⁷/° C., which may be undesirable.

In embodiments, the concentration of R₂O in the glass composition and the resultant multi-phase glass may be greater than or equal to 5.5 mol % and less than or equal to 20 mol %. In embodiments, the concentration of R₂O in the glass composition may be greater than or equal to 5.5 mol %, greater than or equal to 6 mol %, greater than or equal to 6.5 mol %, greater than or equal to 7 mol %, greater than or equal to 7.5 mol %, or even greater than or equal to 8 mol %. In embodiments, the concentration of R₂O in the glass composition and the resultant multi-phase glass may be less than or equal to 20 mol %, less than or equal to 17 mol %, less than or equal to 15 mol %, less than or equal to 14 mol %, less than or equal to 13 mol %, less than or equal to 12 mol %, less than or equal to 11 mol %, or even less than or equal to 10 mol %. In embodiments, the concentration of R₂O in the glass composition and the resultant multi-phase glass may be greater than or equal to 5.5 mol % and less than or equal to 20 mol %, greater than or equal to 5.5 mol % and less than or equal to 17 mol %, greater than or equal to 5.5 mol % and less than or equal to 15 mol %, greater than or equal to 5.5 mol % and less than or equal to 14 mol %, greater than or equal to 5.5 mol % and less than or equal to 13 mol %, greater than or equal to 5.5 mol % and less than or equal to 12 mol %, greater than or equal to 5.5 mol % and less than or equal to 11 mol %, greater than or equal to 5.5 mol % and less than or equal to 10 mol %, greater than or equal to 6 mol % and less than or equal to 20 mol %, greater than or equal to 6 mol % and less than or equal to 17 mol %, greater than or equal to 6 mol % and less than or equal to 15 mol %, greater than or equal to 6 mol % and less than or equal to 14 mol %, greater than or equal to 6 mol % and less than or equal to 13 mol %, greater than or equal to 6 mol % and less than or equal to 12 mol %, greater than or equal to 6 mol % and less than or equal to 11 mol %, greater than or equal to 6 mol % and less than or equal to 10 mol %, greater than or equal to 6.5 mol % and less than or equal to 20 mol %, greater than or equal to 6.5 mol % and less than or equal to 17 mol %, greater than or equal to 6.5 mol % and less than or equal to 15 mol %, greater than or equal to 6.5 mol % and less than or equal to 14 mol %, greater than or equal to 6.5 mol % and less than or equal to 13 mol %, greater than or equal to 6.5 mol % and less than or equal to 12 mol %, greater than or equal to 6.5 mol % and less than or equal to 11 mol %, greater than or equal to 6.5 mol % and less than or equal to 10 mol %, greater than or equal to 7 mol % and less than or equal to 20 mol %, greater than or equal to 7 mol % and less than or equal to 17 mol %, greater than or equal to 7 mol % and less than or equal to 15 mol %, greater than or equal to 7 mol % and less than or equal to 14 mol %, greater than or equal to 7 mol % and less than or equal to 13 mol %, greater than or equal to 7 mol % and less than or equal to 12 mol %, greater than or equal to 7 mol % and less than or equal to 11 mol %, greater than or equal to 7 mol % and less than or equal to 10 mol %, greater than or equal to 7.5 mol % and less than or equal to 20 mol %, greater than or equal to 7.5 mol % and less than or equal to 17 mol %, greater than or equal to 7.5 mol % and less than or equal to 15 mol %, greater than or equal to 7.5 mol % and less than or equal to 14 mol %, greater than or equal to 7.5 mol % and less than or equal to 13 mol %, greater than or equal to 7.5 mol % and less than or equal to 12 mol %, greater than or equal to 7.5 mol % and less than or equal to 11 mol %, greater than or equal to 7.5 mol % and less than or equal to 10 mol %, greater than or equal to 8 mol % and less than or equal to 20 mol %, greater than or equal to 8 mol % and less than or equal to 17 mol %, greater than or equal to 8 mol % and less than or equal to 15 mol %, greater than or equal to 8 mol % and less than or equal to 14 mol %, greater than or equal to 8 mol % and less than or equal to 13 mol %, greater than or equal to 8 mol % and less than or equal to 12 mol %, greater than or equal to 8 mol % and less than or equal to 11 mol %, or even greater than or equal to 8 mol % and less than or equal to 10 mol %, or any and all sub-ranges formed from any of these endpoints.

In embodiments, the ratio of the concentration of R₂O to the concentration of Al₂O₃ (i.e., R₂O (mol %)/Al₂O₃ (mol %)) in the glass composition and the resultant multi-phase glass may be greater than or equal to 0.25 and less than or equal to 2. In embodiments, R₂O/Al₂O₃ in the glass composition and the resultant multi-phase glass may be greater than or equal to 0.25, greater than or equal to 0.5, or even greater than or equal to 0.75. In embodiments, R₂O/Al₂O₃ in the glass composition and the resultant multi-phase glass may be less than or equal to 2, less than or equal to 1.75, less than or equal to 1.5, or even less than or equal to 1.25. In embodiments, R₂O/Al₂O₃ in the glass composition and the resultant multi-phase glass may be greater than or equal to 0.25 and less than or equal to 2, greater than or equal to 0.25 and less than or equal to 1.75, greater than or equal to 0.25 and less than or equal to 1.5, greater than or equal to 0.25 and less than or equal to 1.25, greater than or equal to 0.5 and less than or equal to 2, greater than or equal to 0.5 and less than or equal to 1.75, greater than or equal to 0.5 and less than or equal to 1.5, greater than or equal to 0.5 and less than or equal to 1.25, greater than or equal to 0.75 and less than or equal to 2, greater than or equal to 0.75 and less than or equal to 1.75, greater than or equal to 0.75 and less than or equal to 1.5, or even greater than or equal to 0.75 and less than or equal to 1.25, or any and all sub-ranges formed from any of these endpoints.

In embodiments, the concentration of R₂O minus the concentration of Al₂O₃ (i.e., R₂O (mol %)-Al₂O₃ (mol %)) in the glass composition and the resultant multi-phase glass may be greater than or equal to −3 mol % and less than or equal to 8 mol %. In embodiments, R₂O—Al₂O₃ in the glass composition and the resultant multi-phase glass may be greater than or equal to −3 mol %, greater than or equal to −1 mol %, greater than or even greater than or equal to 0 mol %. In embodiments, R₂O—Al₂O₃ in the glass composition and the resultant multi-phase glass may be less than or equal to 8 mol %, less than or equal to 6 mol %, less than or equal to 4 mol %, or even less than or equal to 2 mol %. In embodiments, R₂O—Al₂O₃ in the glass composition and the resultant multi-phase glass may be greater than or equal to −3 mol % and less than or equal to 8 mol %, greater than or equal to −3 mol % and less than or equal to 6 mol %, greater than or equal to −3 mol % and less than or equal to 4 mol %, greater than or equal to −3 mol % and less than or equal to 2 mol %, greater than or equal to −2 mol % and less than or equal to 8 mol %, greater than or equal to −2 mol % and less than or equal to 6 mol %, greater than or equal to −2 mol % and less than or equal to 4 mol %, greater than or equal to −2 mol % and less than or equal to 2 mol %, greater than or equal to −1 mol % and less than or equal to 8 mol %, greater than or equal to −1 mol % and less than or equal to 6 mol %, greater than or equal to −1 mol % and less than or equal to 4 mol %, greater than or equal to −1 mol % and less than or equal to 2 mol %, greater than or equal to 0 mol % and less than or equal to 8 mol %, greater than or equal to 0 mol % and less than or equal to 6 mol %, greater than or equal to 0 mol % and less than or equal to 4 mol %, or even greater than or equal to 0 mol % and less than or equal to 2 mol %, or any and all sub-ranges formed from any of these endpoints.

In embodiments, the difference in concentration between R₂O and Al₂O₃ minus the concentration of B₂O₃ (i.e., (R₂O (mol %)-Al₂O₃ (mol %))-B₂O₃ (mol %)) in the glass composition and the resultant multi-phase glass may be greater than or equal to −16 mol % and less than or equal to −1 mol %. In embodiments, (R₂O—Al₂O₃)—B₂O₃ in the glass composition and the resultant multi-phase glass may be greater than or equal to −16 mol %, greater than or equal to −14 mol %, or even greater than or equal to −12 mol %. In embodiments, (R₂O—Al₂O₃)—B₂O₃ in the glass composition and the resultant multi-phase glass may be less than or equal to −1 mol %, less than or equal to −3 mol %, less than or equal to −5 mol %, or even less than or equal to −7 mol %. In embodiments, (R₂O—Al₂O₃)—B₂O₃ in the glass composition and the resultant multi-phase glass may be greater than or equal to −16 mol % and less than or equal to −1 mol %, greater than or equal to −16 mol % and less than or equal to −3 mol %, greater than or equal to −16 mol % and less than or equal to −5 mol %, greater than or equal to −16 mol % and less than or equal to −7 mol %, greater than or equal to −14 mol % and less than or equal to −1 mol %, greater than or equal to −14 mol % and less than or equal to −3 mol %, greater than or equal to −14 mol % and less than or equal to −5 mol %, greater than or equal to −14 mol % and less than or equal to −7 mol %, greater than or equal to −12 mol % and less than or equal to −1 mol %, greater than or equal to −12 mol % and less than or equal to −3 mol %, greater than or equal to −12 mol % and less than or equal to −5 mol %, or even greater than or equal to −12 mol % and less than or equal to −7 mol %, or any and all sub-ranges formed from any of these endpoints.

In embodiments, the ratio of the concentration of Li₂O to the concentration of R₂O (i.e., Li₂O (mol %)/R₂O (mol %)) in the glass composition and the resultant multi-phase glass may be greater than or equal to 0.2 and less than or equal to 1. In embodiments, Li₂O/R₂O in the glass composition and the resultant multi-phase glass may be greater than or equal to 0.2, greater than or equal to 0.4, greater than or equal to 0.6, greater than or equal to 0.8, or even greater than or equal to 0.9. In embodiments, Li₂O/R₂O in the glass composition and the resultant multi-phase glass may be less than or equal to 1. In embodiments, Li₂O/R₂O in the glass composition and the resultant multi-phase glass may be greater than or equal to 0.2 and less than or equal to 1, greater than or equal to 0.4 and less than or equal to 1, greater than or equal to 0.6 and less than or equal to 1, greater than or equal to 0.8 and less than or equal to 1, or even greater than or equal to 0.9 and less than or equal to 1, or any and all sub-ranges formed from any of these endpoints.

The glass compositions and resultant multi-phase glasses described herein further comprise MgO. MgO lowers the viscosity of the glass compositions, which enhances the formability and the strain point and increases Young's modulus. However, when too much MgO is added to the glass composition and the resultant multi-phase glass, there is a significant decrease in the diffusivity of sodium and potassium ions in the glass composition which, in turn, adversely impacts the ion exchange performance of the resultant multi-phase glass. In embodiments, the glass composition and the resultant multi-phase glass may comprise greater than or equal to 0.5 mol % and less than or equal to 12 mol % MgO. In embodiments, the glass composition and the resultant multi-phase glass may comprise greater than or equal to 1 mol % and less than or equal to 10 mol % MgO. In embodiments, the concentration of MgO in the glass composition and the resultant multi-phase glass may be greater than or equal to 0.5 mol %, greater than or equal to 1 mol %, greater than or equal to 2 mol %, or even greater than or equal to 3 mol %. In embodiments, the concentration of MgO in the glass composition and the resultant multi-phase glass may be less than or equal to 12 mol %, less than or equal to 10 mol %, less than or equal to 8 mol %, or even less than or equal to 6 mol %. In embodiments, the concentration of MgO in the glass composition and the resultant multi-phase glass may be greater than or equal to 0.5 mol % and less than or equal to 12 mol %, greater than or equal to 0.5 mol % and less than or equal to 10 mol %, greater than or equal to 0.5 mol % and less than or equal to 8 mol %, greater than or equal to 0.5 mol % and less than or equal to 6 mol %, greater than or equal to 1 mol % and less than or equal to 12 mol %, greater than or equal to 1 mol % and less than or equal to 10 mol %, greater than or equal to 1 mol % and less than or equal to 8 mol %, greater than or equal to 1 mol % and less than or equal to 6 mol %, greater than or equal to 2 mol % and less than or equal to 12 mol %, greater than or equal to 2 mol % and less than or equal to 10 mol %, greater than or equal to 2 mol % and less than or equal to 8 mol %, greater than or equal to 2 mol % and less than or equal to 6 mol %, greater than or equal to 3 mol % and less than or equal to 12 mol %, greater than or equal to 3 mol % and less than or equal to 10 mol %, greater than or equal to 3 mol % and less than or equal to 8 mol %, or even greater than or equal to 3 mol % and less than or equal to 6 mol %, or any and all sub-ranges formed from these endpoints.

The glass compositions and the resultant multi-phase glasses described herein may further comprise divalent cation oxides other than MgO, such as CaO, BaO, and SrO.

CaO lowers the viscosity of the glass compositions, which enhances the formability and the strain point and increases Young's modulus. However, when too much CaO is added to the glass composition and the resultant multi-phase glass, there is a significant decrease in the diffusivity of sodium and potassium ions in the glass composition which, in turn, adversely impacts the ion exchange performance of the resultant multi-phase glass. In embodiments, the glass composition and the resultant multi-phase glass may comprise greater than 0 mol % and less than or equal to 10 mol % CaO. In embodiments, the concentration of CaO in the glass composition and the resultant multi-phase glass may be greater than or equal to 0 mol %, greater than or equal to 1 mol %, greater than or equal to 2 mol %, or even greater than or equal to 3 mol %. In embodiments, the concentration of CaO in the glass composition and the resultant multi-phase glass may be less than or equal to 10 mol %, less than or equal to 9 mol %, less than or equal to 8 mol %, less than or equal to 7 mol %, or even less than or equal to 6 mol %. In embodiments, the concentration of CaO in the glass composition and the resultant multi-phase glass may be greater than or equal to 0 mol % and less than or equal to 10 mol %, greater than or equal to 0 mol % and less than or equal to 9 mol %, greater than or equal to 0 mol % and less than or equal to 8 mol %, greater than or equal to 0 mol % and less than or equal to 7 mol %, greater than or equal to 0 mol % and less than or equal to 6 mol %, greater than or equal to 1 mol % and less than or equal to 10 mol %, greater than or equal to 1 mol % and less than or equal to 9 mol %, greater than or equal to 1 mol % and less than or equal to 8 mol %, greater than or equal to 1 mol % and less than or equal to 7 mol %, greater than or equal to 1 mol % and less than or equal to 6 mol %, greater than or equal to 2 mol % and less than or equal to 10 mol %, greater than or equal to 2 mol % and less than or equal to 9 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 3 mol % and less than or equal to 10 mol %, greater than or equal to 3 mol % and less than or equal to 9 mol %, greater than or equal to 3 mol % and less than or equal to 8 mol %, greater than or equal to 3 mol % and less than or equal to 7 mol %, or even greater than or equal to 3 mol % and less than or equal to 6 mol %, or any and all sub-ranges formed from any of these endpoints. In embodiments, the glass composition and the resultant multi-phase glass may be free or substantially free of CaO.

In embodiments, the glass composition and the resultant multi-phase glass may comprise greater than 0 mol % and less than or equal to 5 mol % BaO. In embodiments, the concentration of BaO in the glass composition and the resultant multi-phase glass may be greater than or equal to 0 mol %, greater than or equal to 0.5 mol %, or even greater than or equal to 1 mol %. In embodiments, the concentration of BaO in the glass composition and the resultant multi-phase glass may be less than or equal to 5 mol %, less than or equal to 4 mol %, or even less than or equal to 3. In embodiments, the concentration of BaO in the glass composition and the resultant multi-phase glass may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0.5 mol % and less than or equal to 5 mol %, greater than or equal to 0.5 mol % and less than or equal to 4 mol %, greater than or equal to 0.5 mol % and less than or equal to 2 mol %, greater than or equal to 1 mol % and less than or equal to 5 mol %, greater than or equal to 1 mol % and less than or equal to 4 mol %, or even greater than or equal to 1 mol % and less than or equal to 3 mol %, or any and all sub-ranges formed from any of these endpoints. In embodiments, the glass composition and the resultant multi-phase glass may be free or substantially free of BaO.

In embodiments, the glass composition and the resultant multi-phase glass may comprise greater than 0 mol % and less than or equal to 2 mol % SrO. In embodiments, the concentration of SrO in the glass composition and the resultant multi-phase glass may be greater than or equal to 0 mol % or even greater than or equal to 0.1 mol %. In embodiments, the concentration of SrO in the glass composition and the resultant multi-phase glass may be less than or equal to 2 mol %, less than or equal to 1.5 mol %, less than or equal to 1 mol %, less than or equal to 0.5 mol %, or even less than or equal to 0.25 mol %. In embodiments, the concentration of SrO in the glass composition and the resultant multi-phase glass may be greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, greater than or equal to 0 mol % and less than or equal to 0.25 mol %, greater than or equal to 0.1 mol % and less than or equal to 2 mol %, greater than or equal to 0.1 mol % and less than or equal to 1.5 mol %, greater than or equal to 0.1 mol % and less than or equal to 1 mol %, greater than or equal to 0.1 mol % and less than or equal to 0.5 mol %, or even greater than or equal to 0.1 mol % and less than or equal to 0.25 mol %, or any and all sub-ranges formed from any of these endpoints. In embodiments, the glass composition and the resultant multi-phase glass may be free or substantially free of SrO.

RO is the sum (in mol %) of MgO, CaO, BaO, and SrO present in the glass composition and the resultant multi-phase glass (i.e., RO═MgO (mol %)+CaO (mol %)+BaO (mol %)+SrO (mol %)). The concentration of RO in the glass composition and the resultant multi-phase glass should be sufficiently high (e.g., greater than or equal to 5.5 mol %) to enable the development of multiple phases through phase separation. The concentration of RO in the glass composition and the resultant multi-phase glass may be limited (e.g., less than or equal to 14 mol %) to enable relatively fast ion exchange. In embodiments, the concentration of RO in the glass composition and the resultant multi-phase glass may be greater than or equal to 5.5 mol % and less than or equal to 14 mol %. In embodiments, the concentration of RO in the glass composition and the resultant multi-phase glass may be greater than or equal to 6 mol % and less than or equal to 13 mol %. In embodiments, the concentration of RO in the glass composition and the resultant multi-phase glass may be greater than or equal to 5.5 mol %, greater than or equal to 6 mol %, greater than or equal to 6.5 mol %, greater than or equal to 7 mol %, greater than or equal to 7.5 mol %, or even greater than or equal to 8 mol %. In embodiments, the concentration of RO in the glass composition and the resultant multi-phase glass may be less than or equal to 14 mol %, less than or equal to 13 mol %, less than or equal to 12 mol %, less than or equal to 11 mol %, or even less than or equal to 10 mol %. In embodiments, the concentration of RO in the glass composition and the resultant multi-phase glass may be greater than or equal to 5.5 mol % and less than or equal to 14 mol %, greater than or equal to 5.5 mol % and less than or equal to 13 mol %, greater than or equal to 5.5 mol % and less than or equal to 12 mol %, greater than or equal to 5.5 mol % and less than or equal to 11 mol %, greater than or equal to 5.5 mol % and less than or equal to 10 mol %, greater than or equal to 6 mol % and less than or equal to 14 mol %, greater than or equal to 6 mol % and less than or equal to 13 mol %, greater than or equal to 6 mol % and less than or equal to 12 mol %, greater than or equal to 6 mol % and less than or equal to 11 mol %, greater than or equal to 6 mol % and less than or equal to 10 mol %, greater than or equal to 6.5 mol % and less than or equal to 14 mol %, greater than or equal to 6.5 mol % and less than or equal to 13 mol %, greater than or equal to 6.5 mol % and less than or equal to 12 mol %, greater than or equal to 6.5 mol % and less than or equal to 11 mol %, greater than or equal to 6.5 mol % and less than or equal to 10 mol %, greater than or equal to 7 mol % and less than or equal to 14 mol %, greater than or equal to 7 mol % and less than or equal to 13 mol %, greater than or equal to 7 mol % and less than or equal to 12 mol %, greater than or equal to 7 mol % and less than or equal to 11 mol %, greater than or equal to 7 mol % and less than or equal to 10 mol %, greater than or equal to 7.5 mol % and less than or equal to 14 mol %, greater than or equal to 7.5 mol % and less than or equal to 13 mol %, greater than or equal to 7.5 mol % and less than or equal to 12 mol %, greater than or equal to 7.5 mol % and less than or equal to 11 mol %, greater than or equal to 7.5 mol % and less than or equal to 10 mol %, greater than or equal to 8 mol % and less than or equal to 14 mol %, greater than or equal to 8 mol % and less than or equal to 13 mol %, greater than or equal to 8 mol % and less than or equal to 12 mol %, greater than or equal to 8 mol % and less than or equal to 11 mol %, or even greater than or equal to 8 mol % and less than or equal to 10 mol %, or any and all sub-ranges formed from any of these endpoints.

In embodiment, the sum of the concentration of B₂O₃ and the concentration of RO (i.e., B₂O₃ (mol %)+RO (mol %)) in the glass composition and the resultant multi-phase glass may be sufficiently high (e.g., greater than or equal to 10.5 mol %) to enable the development of multiple phases through phase separation. In embodiments, B₂O₃+RO in the glass composition and the resultant multi-phase may be greater than or equal to 10.5 mol % and less than or equal to 29 mol %. In embodiments, B₂O₃+RO in the glass composition and the resultant multi-phase may be greater than or equal to 10.5 mol %, greater than or equal to 11.5 mol %, greater than or equal to 12.5 mol %, greater than or equal to 13.5 mol %, greater than or equal to 14.5 mol %, or even greater than or equal to 15.5 mol %. In embodiments, B₂O₃+RO in the glass composition and the resultant multi-phase may be less than or equal to 29 mol %, less than or equal to 27 mol %, less than or equal to 25 mol %, less than or equal to 23 mol %, less than or equal to 21 mol %, or even less than or equal to 19 mol %. In embodiments, B₂O₃+RO in the glass composition and the resultant multi-phase may be greater than or equal to 10.5 mol % and less than or equal to 29 mol %, greater than or equal to 10.5 mol % and less than or equal to 27 mol %, greater than or equal to 10.5 mol % and less than or equal to 25 mol %, greater than or equal to 10.5 mol % and less than or equal to 23 mol %, greater than or equal to 10.5 mol % and less than or equal to 21 mol %, greater than or equal to 10.5 mol % and less than or equal to 19 mol %, greater than or equal to 11.5 mol % and less than or equal to 29 mol %, greater than or equal to 11.5 mol % and less than or equal to 27 mol %, greater than or equal to 11.5 mol % and less than or equal to 25 mol %, greater than or equal to 11.5 mol % and less than or equal to 23 mol %, greater than or equal to 11.5 mol % and less than or equal to 21 mol %, greater than or equal to 11.5 mol % and less than or equal to 19 mol %, greater than or equal to 12.5 mol % and less than or equal to 29 mol %, greater than or equal to 12.5 mol % and less than or equal to 27 mol %, greater than or equal to 12.5 mol % and less than or equal to 25 mol %, greater than or equal to 12.5 mol % and less than or equal to 23 mol %, greater than or equal to 12.5 mol % and less than or equal to 21 mol %, greater than or equal to 12.5 mol % and less than or equal to 19 mol %, greater than or equal to 13.5 mol % and less than or equal to 29 mol %, greater than or equal to 13.5 mol % and less than or equal to 27 mol %, greater than or equal to 13.5 mol % and less than or equal to 25 mol %, greater than or equal to 13.5 mol % and less than or equal to 23 mol %, greater than or equal to 13.5 mol % and less than or equal to 21 mol %, greater than or equal to 13.5 mol % and less than or equal to 19 mol %, greater than or equal to 14.5 mol % and less than or equal to 29 mol %, greater than or equal to 14.5 mol % and less than or equal to 27 mol %, greater than or equal to 14.5 mol % and less than or equal to 25 mol %, greater than or equal to 14.5 mol % and less than or equal to 23 mol %, greater than or equal to 14.5 mol % and less than or equal to 21 mol %, greater than or equal to 14.5 mol % and less than or equal to 19 mol %, greater than or equal to 10.5 mol % and less than or equal to 29 mol %, greater than or equal to 15.5 mol % and less than or equal to 27 mol %, greater than or equal to 15.5 mol % and less than or equal to 25 mol %, greater than or equal to 15.5 mol % and less than or equal to 23 mol %, greater than or equal to 15.5 mol % and less than or equal to 21 mol %, or even greater than or equal to 15.5 mol % and less than or equal to 19 mol %, or any and all sub-ranges formed from any of these endpoints.

In embodiments, the concentration of RO minus the concentration of B₂O₃ (i.e., RO (mol %)-B₂O₃ (mol %)) in the glass composition and the resultant multi-phase glass may be greater than or equal to −7 mol % and less than or equal to 7 mol %. In embodiments, RO—B₂O₃ in the glass composition and the resultant multi-phase glass may be greater than or equal to −7 mol %, greater than or equal to −5 mol %, greater than or equal to −3 mol %, or even greater than or equal to −1 mol %. In embodiments, RO—B₂O₃ in the glass composition and the resultant multi-phase glass may be less than or equal to 7 mol %, less than or equal to 5 mol %, less than or equal to 3 mol %, or even less than or equal to 1 mol %. In embodiments, RO—B₂O₃ in the glass composition and the resultant multi-phase glass may be greater than or equal to −7 mol % and less than or equal to 7 mol %, greater than or equal to −7 mol % and less than or equal to 5 mol %, greater than or equal to −7 mol % and less than or equal to 3 mol %, greater than or equal to −7 mol % and less than or equal to 1 mol %, greater than or equal to −5 mol % and less than or equal to 7 mol %, greater than or equal to −5 mol % and less than or equal to 5 mol %, greater than or equal to −5 mol % and less than or equal to 3 mol %, greater than or equal to −5 mol % and less than or equal to 1 mol %, greater than or equal to −3 mol % and less than or equal to 7 mol %, greater than or equal to −3 mol % and less than or equal to 5 mol %, greater than or equal to −3 mol % and less than or equal to 3 mol %, greater than or equal to −3 mol % and less than or equal to 1 mol %, greater than or equal to −1 mol % and less than or equal to 7 mol %, greater than or equal to −1 mol % and less than or equal to 5 mol %, greater than or equal to −1 mol % and less than or equal to 3 mol %, or even greater than or equal to −1 mol % and less than or equal to 1 mol %, or any and all sub-ranges formed from any of these endpoints.

In embodiments, the difference in concentration between RO and Al₂O₃ minus the concentration of B₂O₃ (i.e., (RO (mol %)-Al₂O₃ (mol %))-B₂O₃ (mol %)) in the glass composition and the resultant multi-phase glass may be greater than or equal to −8 mol % and less than or equal to 10 mol %. In embodiments, (RO—Al₂O₃)—B₂O₃ in the glass composition and the resultant multi-phase glass may be greater than or equal to −12 mol %, greater than or equal to −10 mol %, greater than or equal to −8 mol %, greater than or equal to −6 mol %, greater than or equal to −4 mol %, greater than or equal to −2 mol %, or even greater than or equal to 0 mol %. In embodiments, (RO—Al₂O₃)—B₂O₃ in the glass composition and the resultant multi-phase glass may be less than or equal to 10 mol %, less than or equal to 8 mol %, less than or equal to 6 mol %, less than or equal to 4 mol %, or even less than or equal to 2 mol %. In embodiments, (RO—Al₂O₃)—B₂O₃ in the glass composition and the resultant multi-phase glass may be greater than or equal to −12 mol % and less than or equal to 10 mol %, greater than or equal to −12 mol % and less than or equal to 8 mol %, greater than or equal to −12 mol % and less than or equal to 6 mol %, greater than or equal to −12 mol % and less than or equal to 4 mol %, greater than or equal to −12 mol % and less than or equal to 2 mol %, greater than or equal to −10 mol % and less than or equal to 10 mol %, greater than or equal to −10 mol % and less than or equal to 8 mol %, greater than or equal to −10 mol % and less than or equal to 6 mol %, greater than or equal to −10 mol % and less than or equal to 4 mol %, greater than or equal to −10 mol % and less than or equal to 2 mol %, greater than or equal to −8 mol % and less than or equal to 10 mol %, greater than or equal to −8 mol % and less than or equal to 8 mol %, greater than or equal to −8 mol % and less than or equal to 6 mol %, greater than or equal to −8 mol % and less than or equal to 4 mol %, greater than or equal to −8 mol % and less than or equal to 2 mol %, greater than or equal to −6 mol % and less than or equal to 10 mol %, greater than or equal to −6 mol % and less than or equal to 8 mol %, greater than or equal to −6 mol % and less than or equal to 6 mol %, greater than or equal to −6 mol % and less than or equal to 4 mol %, greater than or equal to −6 mol % and less than or equal to 2 mol %, greater than or equal to −4 mol % and less than or equal to 10 mol %, greater than or equal to −4 mol % and less than or equal to 8 mol %, greater than or equal to −4 mol % and less than or equal to 6 mol %, greater than or equal to −4 mol % and less than or equal to 4 mol %, greater than or equal to −4 mol % and less than or equal to 2 mol %, greater than or equal to −2 mol % and less than or equal to 10 mol %, greater than or equal to −2 mol % and less than or equal to 8 mol %, greater than or equal to −2 mol % and less than or equal to 6 mol %, greater than or equal to −2 mol % and less than or equal to 4 mol %, greater than or equal to −2 mol % and less than or equal to 2 mol %, greater than or equal to 0 mol % and less than or equal to 10 mol %, greater than or equal to 0 mol % and less than or equal to 8 mol %, greater than or equal to 0 mol % and less than or equal to 6 mol %, greater than or equal to 0 mol % and less than or equal to 4 mol %, or even greater than or equal to 0 mol % and less than or equal to 2 mol %, or any and all sub-ranges formed from any of these endpoints.

In embodiments, the glass compositions and the resultant multi-phase glasses described herein may further comprise ZrO₂, Y₂O₃, and/or TiO₂ to increase the fracture toughness and Young's modulus of the resultant multi-phase glass. In embodiments, the sum of ZrO₂, Y₂O₃, and TiO₂ (i.e., ZrO₂ (mol %)+Y₂O₃ (mol %)+TiO₂ (mol %)) in the glass composition and the resultant multi-phase glass may be greater than 0 mol % and less than or equal to 10 mol %. In embodiments, ZrO₂+Y₂O₃+TiO₂ in the glass composition and the resultant multi-phase glass may be greater than or equal to 0 mol %, greater than or equal to 1 mol %, greater than or equal to 2 mol %, or even greater than or equal to 3 mol %. In embodiments, ZrO₂+Y₂O₃+TiO₂ in the glass composition and the resultant multi-phase glass may be less than or equal to 10 mol %, less than or equal to 8 mol %, or even less than or equal to 6 mol %. In embodiments, ZrO₂+Y₂O₃+TiO₂ in the glass composition and the resultant multi-phase glass may be greater than or equal to 0 mol % and less than or equal to 10 mol %, greater than or equal to 0 mol % and less than or equal to 8 mol %, greater than or equal to 0 mol % and less than or equal to 6 mol %, greater than or equal to 1 mol % and less than or equal to 10 mol %, greater than or equal to 1 mol % and less than or equal to 8 mol %, greater than or equal to 1 mol % and less than or equal to 6 mol %, greater than or equal to 2 mol % and less than or equal to 10 mol %, greater than or equal to 2 mol % and less than or equal to 8 mol %, greater than or equal to 2 mol % and less than or equal to 6 mol %, greater than or equal to 3 mol % and less than or equal to 10 mol %, greater than or equal to 3 mol % and less than or equal to 8 mol %, or even greater than or equal to 3 mol % and less than or equal to 6 mol %, or any and all sub-ranges formed from any of these endpoints. In embodiments, the glass composition and the resultant multi-phase glass may be free or substantially free of ZrO₂+Y₂O₃+TiO₂.

In embodiments, the glass composition and the resultant multi-phase glass may comprise greater than 0 mol % and less than or equal to 10 mol % ZrO₂. In embodiments, the concentration of ZrO₂ in the glass composition and the resultant multi-phase glass may be greater than or equal to 0 mol %, greater than or equal to 0.1 mol %, greater than or equal to 0.5 mol %, greater than or equal to 1 mol %, greater than or equal to 2 mol %, or even greater than or equal to 3 mol %. In embodiments, the concentration of ZrO₂ in the glass composition and the resultant multi-phase glass may be less than or equal to 10 mol %, less than or equal to 8 mol %, or even less than or equal to 6 mol %. In embodiments, the concentration of ZrO₂ in the glass composition and the resultant multi-phase glass may be greater than or equal to 0 mol % and less than or equal to 10 mol %, greater than or equal to 0 mol % and less than or equal to 8 mol %, greater than or equal to 0 mol % and less than or equal to 6 mol %, greater than or equal to 0.1 mol % and less than or equal to 10 mol %, greater than or equal to 0.1 mol % and less than or equal to 8 mol %, greater than or equal to 0.1 mol % and less than or equal to 6 mol %, greater than or equal to 0.5 mol % and less than or equal to 10 mol %, greater than or equal to 0.5 mol % and less than or equal to 8 mol %, greater than or equal to 0.5 mol % and less than or equal to 6 mol %, greater than or equal to 1 mol % and less than or equal to 10 mol %, greater than or equal to 1 mol % and less than or equal to 8 mol %, greater than or equal to 1 mol % and less than or equal to 6 mol %, greater than or equal to 2 mol % and less than or equal to 10 mol %, greater than or equal to 2 mol % and less than or equal to 8 mol %, greater than or equal to 2 mol % and less than or equal to 6 mol %, greater than or equal to 3 mol % and less than or equal to 10 mol %, greater than or equal to 3 mol % and less than or equal to 8 mol %, or even greater than or equal to 3 mol % and less than or equal to 6 mol %, or any and all sub-ranges formed from any of these endpoints. In embodiments, the glass composition and the resultant multi-phase glass may be free or substantially free of ZrO₂.

In embodiments, the glass composition and the resultant multi-phase glass may comprise greater than 0 mol % and less than or equal to 10 mol % Y₂O₃. In embodiments, the concentration of Y₂O₃ in the glass composition and the resultant multi-phase glass may be greater than or equal to 0 mol %, greater than or equal to 0.1 mol %, greater than or equal to 0.5 mol %, greater than or equal to 1 mol %, greater than or equal to 2 mol %, or even greater than or equal to 3 mol %. In embodiments, the concentration of Y₂O₃ in the glass composition and the resultant multi-phase glass may be less than or equal to 10 mol %, less than or equal to 8 mol %, or even less than or equal to 6 mol %. In embodiments, the concentration of Y₂O₃ in the glass composition and the resultant multi-phase glass may be greater than or equal to 0 mol % and less than or equal to 10 mol %, greater than or equal to 0 mol % and less than or equal to 8 mol %, greater than or equal to 0 mol % and less than or equal to 6 mol %, greater than or equal to 0.1 mol % and less than or equal to 10 mol %, greater than or equal to 0.1 mol % and less than or equal to 8 mol %, greater than or equal to 0.1 mol % and less than or equal to 6 mol %, greater than or equal to 0.5 mol % and less than or equal to 10 mol %, greater than or equal to 0.5 mol % and less than or equal to 8 mol %, greater than or equal to 0.5 mol % and less than or equal to 6 mol %, greater than or equal to 1 mol % and less than or equal to 10 mol %, greater than or equal to 1 mol % and less than or equal to 8 mol %, greater than or equal to 1 mol % and less than or equal to 6 mol %, greater than or equal to 2 mol % and less than or equal to 10 mol %, greater than or equal to 2 mol % and less than or equal to 8 mol %, greater than or equal to 2 mol % and less than or equal to 6 mol %, greater than or equal to 3 mol % and less than or equal to 10 mol %, greater than or equal to 3 mol % and less than or equal to 8 mol %, or even greater than or equal to 3 mol % and less than or equal to 6 mol %, or any and all sub-ranges formed from any of these endpoints. In embodiments, the glass composition and the resultant multi-phase glass may be free or substantially free of Y₂O₃.

In embodiments, the glass composition and the resultant multi-phase glass may comprise greater than 0 mol % and less than or equal to 10 mol % TiO₂. In embodiments, the concentration of TiO₂ in the glass composition and the resultant multi-phase glass may be greater than or equal to 0 mol %, greater than or equal to 0.1 mol %, greater than or equal to 0.5 mol %, greater than or equal to 1 mol %, or even greater than or equal to 2 mol %. In embodiments, the concentration of TiO₂ in the glass composition and the resultant multi-phase glass may be less than or equal to 10 mol %, less than or equal to 8 mol %, less than or equal to 6 mol %, or even less than or equal to 4 mol %. In embodiments, the concentration of TiO₂ in the glass composition and the resultant multi-phase glass may be greater than or equal to 0 mol % and less than or equal to 10 mol %, greater than or equal to 0 mol % and less than or equal to 8 mol %, greater than or equal to 0 mol % and less than or equal to 6 mol %, greater than or equal to 0 mol % and less than or equal to 4 mol %, greater than or equal to 0.1 mol % and less than or equal to 10 mol %, greater than or equal to 0.1 mol % and less than or equal to 8 mol %, greater than or equal to 0.1 mol % and less than or equal to 6 mol %, greater than or equal to 0.1 mol % and less than or equal to 4 mol %, greater than or equal to 0.5 mol % and less than or equal to 10 mol %, greater than or equal to 0.5 mol % and less than or equal to 8 mol %, greater than or equal to 0.5 mol % and less than or equal to 6 mol %, greater than or equal to 0.5 mol % and less than or equal to 4 mol %, greater than or equal to 1 mol % and less than or equal to 10 mol %, greater than or equal to 1 mol % and less than or equal to 8 mol %, greater than or equal to 1 mol % and less than or equal to 6 mol %, greater than or equal to 1 mol % and less than or equal to 4 mol %, greater than or equal to 2 mol % and less than or equal to 10 mol %, greater than or equal to 2 mol % and less than or equal to 8 mol %, greater than or equal to 2 mol % and less than or equal to 6 mol %, or even greater than or equal to 2 mol % and less than or equal to 4 mol %, or any and all sub-ranges formed from any of these endpoints. In embodiments, the glass composition and the resultant multi-phase glass may be free or substantially free of TiO₂.

In embodiments, the glass compositions and the resultant multi-phase glasses described herein may further include one or more fining agents. In embodiments, the fining agents may include, for example, SnO₂. In embodiments, the concentration of SnO₂ in the glass composition and the resultant multi-phase glass may be greater than or equal to 0 mol %. In embodiments, the concentration of SnO₂ in the glass composition and the resultant multi-phase glass may be less than or equal to 0.5 mol %, less than or equal to 0.4 mol %, less than or equal to 0.3 mol %, or even less than or equal to 0.2 mol %. In embodiments, the concentration of SnO₂ in the glass composition and the resultant multi-phase glass may be greater than or equal to 0 mol % and less than or equal to 0.5 mol %, greater than or equal to 0 mol % and less than or equal to 0.4 mol %, greater than or equal to 0 mol % and less than or equal to 0.3 mol %, or even greater than or equal to 0 mol % and less than or equal to 0.2 mol %, or any and all sub-ranges formed from any of these endpoints. In embodiments, the glass composition and the resultant multi-phase glass may be free or substantially free of SnO₂.

In embodiments, the glass compositions and the resultant multi-phase glasses described herein may further comprise P₂O₅. In embodiments, the concentration of P₂O₅ in the glass composition and the resultant multi-phase glass may be greater than or equal to 0 mol %. In embodiments, the concentration of P₂O₅ in the glass composition and the resultant multi-phase glass may be less than or equal to 0.5 mol %, less than or equal to 0.4 mol %, less than or equal to 0.3 mol %, less than or equal to 0.2 mol %, or even less than or equal to 0.1 mol %. In embodiments, the concentration of P₂O₅ in the glass composition and the resultant multi-phase glass may be greater than or equal to 0 mol % and less than or equal to 0.5 mol %, greater than or equal to 0 mol % and less than or equal to 0.4 mol %, greater than or equal to 0 mol % and less than or equal to 0.3 mol %, greater than or equal to 0 mol % and less than or equal to 0.2 mol %, or even greater than or equal to 0 mol % and less than or equal to 0.1 mol %, or any and all sub-ranges formed from any of these endpoints. In embodiments, the glass composition and the resultant multi-phase glass may be free or substantially free of P₂O₅.

The glass compositions and the resultant multi-phase glass described herein may be free of at least one of La₂O₃ and Yb₂O₃.

In embodiments, the glass compositions and the resultant multi-phase glasses described herein may further include tramp materials such as FeO, MnO, MoO₃, CdO, As₂O₃, Sb₂O₃, sulfur-based compounds, such as sulfates, halogens, or combinations thereof.

In embodiments, the glass composition may comprise: greater than or equal to 45 mol % and less than or equal to 70 mol % SiO₂; greater than or equal to 5 mol % and less than or equal to 15 mol % Al₂O₃; greater than or equal to 5 mol % and less than or equal to 15 mol % B₂O₃; greater than or equal to 5.5 mol % and less than or equal to 15 mol % Li₂O; and greater than or equal to 0.5 mol % and less than or equal to 12 mol % MgO, wherein RO may be greater than or equal 5.5 mol % and less than or equal to 14 mol %, wherein RO is the sum of MgO, CaO, BaO, and SrO, the glass composition may be free of at least one of La₂O₃ and Yb₂O₃, and the glass composition may be phase separable.

The glass compositions described herein are spontaneously phase separable and do not require an additional heat treatment step after formation of the glass to achieve phase separation. Accordingly, in embodiments, the process for forming a multi-phase glass includes heating a glass composition described herein at one or more preselected temperatures for one or more preselected times to melt the glass composition and cooling the glass composition to induce phase separation. In embodiments, the method for forming a multi-phase glass may include (i) heating a glass composition at a rate of 1 to 100° C./min to a glass melting temperature; (ii) maintaining the glass composition at the glass melting temperature for a time greater than or equal to 4 hours and less than or equal to 16 hours; and (iii) cooling the glass composition to room temperature to form the multi-phase glass. In embodiments, the glass melting temperature may be greater than or equal to 1500° C. and less than or equal to 1700° C.

In embodiments, the multi-phase glass may include at least two phases. In embodiments, the at least two phases may comprise at least two glass phases. In embodiments, during the cooling step, the glass composition undergoes decomposition which may be spinodal dispersed particles. In embodiments, the glass compositions described herein may separate into a silica-rich phase and a modifier-rich phase.

In embodiments, the multi-phase glass may be transparent.

In embodiments, the multi-phase glass may have a Young's modulus greater than or equal to 70 GPa. In embodiments, the multi-phase glass may have a Young's modulus greater than or equal to 70 GPa, greater than or equal to 75 GPa, or even greater than or equal to 80 GPa. In embodiments, the multi-phase glass may have a Young's modulus less than or equal to 100 GPa, less than or equal to 95 GPa, or even less than or equal to 90 GPa. In embodiments, the multi-phase glass may have a Young's modulus greater than or equal to 70 GPa and less than or equal to 100 GPa, greater than or equal to 70 GPa and less than or equal to 95 GPa, greater than or equal to 70 GPa and less than or equal to 90 GPa, greater than or equal to 75 GPa and less than or equal to 100 GPa, greater than or equal to 75 GPa and less than or equal to 95 GPa, greater than or equal to 75 GPa and less than or equal to 90 GPa, greater than or equal to 80 GPa and less than or equal to 100 GPa, greater than or equal to 80 GPa and less than or equal to 95 GPa, or even greater than or equal to 80 GPa and less than or equal to 90 GPa, or any and all sub-ranges formed from any of these endpoints.

In embodiments, the glass composition and the resultant multi-phase glass may have a fracture toughness greater than or equal to 0.6 MPa·m^{1/2}, greater than or equal to 0.7 MPa·m^{1/2}, or even greater than or equal to 0.8 MPa·m^{1/2}.

In embodiments, the multi-phase glass may have a density greater than or equal to 2.25 g/cm³, greater than or equal to 2.3 g/cm³, or even greater than or equal to 2.35 g/cm³. In embodiments, the multi-phase glass may have a density less than or equal to 2.55 g/cm³, less than or equal to 2.5 g/cm³, or even less than or equal to 2.45 g/cm³. In embodiments, the multi-phase glass may have a density greater than or equal to 2.25 g/cm³ and less than or equal to 2.55 g/cm³, greater than or equal to 2.25 g/cm³ and less than or equal to 2.5 g/cm³, greater than or equal to 2.25 g/cm³ and less than or equal to 2.45 g/cm³, greater than or equal to 2.3 g/cm³ and less than or equal to 2.55 g/cm³, greater than or equal to 2.3 g/cm³ and less than or equal to 2.5 g/cm³, greater than or equal to 2.3 g/cm³ and less than or equal to 2.45 g/cm³, greater than or equal to 2.35 g/cm³ and less than or equal to 2.55 g/cm³, greater than or equal to 2.35 g/cm³ and less than or equal to 2.5 g/cm³, or even greater than or equal to 2.35 g/cm³ and less than or equal to 2.45 g/cm³, or any and all sub-ranges formed from any of these endpoints.

In embodiments, the multi-phase glass may have a shear modulus greater than or equal to 25 GPa, greater than or equal to 27 GPa, or even greater than or equal to 30 GPa. In embodiments, the multi-phase glass may have a shear modulus less than or equal to 42 GPa, less than or equal to 40 GPa, or even less than or equal to 30 GPa. In embodiments, the multi-phase glass may have a shear modulus greater than or equal to 25 GPa and less than or equal to 42 GPa, greater than or equal to 25 GPa and less than or equal to 40 GPa, greater than or equal to 25 GPa and less than or equal to 38 GPa, greater than or equal to 27 GPa and less than or equal to 42 GPa, greater than or equal to 27 GPa and less than or equal to 40 GPa, greater than or equal to 27 GPa and less than or equal to 38 GPa, greater than or equal to 30 GPa and less than or equal to 42 GPa, greater than or equal to 30 GPa and less than or equal to 40 GPa, or even greater than or equal to 30 GPa and less than or equal to 38 GPa, or any and all sub-ranges formed from any of these endpoints.

In embodiments, the multi-phase glass may have a Poisson's ratio greater than or equal to 0.15 or even greater than or equal to 0.2. In embodiments, the multi-phase glass may have a Poisson's ratio less than or equal to 0.3 or even less than or equal to 0.25. In embodiments, the multi-phase glass may have a Poisson's ratio greater than or equal to 0.15 and less than or equal to 0.3, greater than or equal to 0.15 and less than or equal to 0.25, greater than or equal to 0.2 and less than or equal to 0.3, or even greater than or equal to 0.2 and less than or equal to 0.25, or any and all sub-ranges formed from any of these endpoints.

In embodiments, the multi-phase glass may have a stress optical coefficient (SOC) greater than or equal to 2.25 nm/mm/MPa or even greater than or equal to 2.5 nm/mm/MPa. In embodiments, the multi-phase glass may have a SOC less than or equal to 3.75 nm/mm/MPa or even less than or equal to 3.5 nm/mm/MPa. In embodiments, the multi-phase glass may have a SOC greater than or equal to 2.25 nm/mm/MPa and less than or equal to 3.75 nm/mm/MPa, greater than or equal to 2.25 nm/mm/MPa and less than or equal to 3.5 nm/mm/MPa, greater than or equal to 2.5 nm/mm/MPa and less than or equal to 3.75 nm/mm/MPa, or even greater than or equal to 2.5 nm/mm/MPa and less than or equal to 3.5 nm/mm/MPa, or any and all sub-ranges formed from any of these endpoints.

In embodiments, the multi-phase glass may have a refractive index greater than or equal to 1.4, greater than or equal to 1.45, or even greater than or equal to 1.5. In embodiments, the multi-phase glass may have a refractive index less than or equal to 1.6 or even less than or equal to 1.55. In embodiments, the multi-phase glass may have a refractive index greater than or equal to 1.4 and less than or equal to 1.6, greater than or equal to 1.4 and less than or equal to 1.55, greater than or equal to 1.45 and less than or equal to 1.6, greater than or equal to 1.45 and less than or equal to 1.55, greater than or equal to 1.5 and less than or equal to 1.6, or even greater than or equal to 1.5 and less than or equal to 1.55, or any and all sub-ranges formed from any of these endpoints.

In embodiments, the multi-phase glass may have a dielectric constant Dk greater than or equal to 6.0, greater than or equal to 6.2, greater than or equal to 6.4, or even greater than or equal to 6.6, as measured at 10 GHz. In embodiments, the multi-phase glass may have a dielectric constant Dk less than or equal to 7.5, less than or equal to 7.3, or even less than or equal to 7.0, as measured at 10 GHz. In embodiments, the multi-phase glass may have a dielectric constant greater than or equal to 6.0 and less than or equal to 7.5, greater than or equal to 6.0 and less than or equal to 7.3, greater than or equal to 6.0 and less than or equal to 7.0, greater than or equal to 6.2 and less than or equal to 7.5, greater than or equal to 6.2 and less than or equal to 7.3, greater than or equal to 6.2 and less than or equal to 7.0, greater than or equal to 6.4 and less than or equal to 7.5, greater than or equal to 6.4 and less than or equal to 7.3, greater than or equal to 6.4 and less than or equal to 7.0, greater than or equal to 6.6 and less than or equal to 7.5, greater than or equal to 6.6 and less than or equal to 7.3, or even greater than or equal to 6.6 and less than or equal to 7.0, or any and all sub-ranges formed from any of these endpoints, as measured at 10 GHz.

In embodiments, the multi-phase glass may have a dissipation factor Df greater than or equal to 0.008 or even greater than or equal to 0.009, as measured at 10 GHz. In embodiments, the multi-phase glass may have a dissipation factor Df less than or equal to 0.02, less than or equal to 0.015, or even less than or equal to 0.01, as measured at 10 GHz. In embodiments, the multi-phase glass may have a dissipation factor Df greater than or equal to 0.008 and less than or equal to 0.02, greater than or equal to 0.008 and less than or equal to 0.015, greater than or equal to 0.008 and less than or equal to 0.01, greater than or equal to 0.009 and less than or equal to 0.02, greater than or equal to 0.009 and less than or equal to 0.015, or even greater than or equal to 0.009 and less than or equal to 0.01, or any and all sub-ranges formed from any of these endpoints, as measured at 10 GHz.

The multi-phase glass formed from the glass compositions described herein may be any suitable shape or thickness, which may vary depending on the particular application for use of the multi-phase glass. Glass sheet embodiments may have a thickness greater than or equal to 30 μm, greater than or equal to 50 μm, greater than or equal to 100 μm, greater than or equal to 250 μm, greater than or equal to 500 μm, greater than or equal to 750 μm, or even greater than or equal to 1 mm. In embodiments, the glass sheet embodiments may have a thickness less than or equal to 6 mm, less than or equal to 5 mm, less than or equal to 4 mm, less than or equal to 3 mm, or even less than or equal to 2 mm. In embodiments, the glass sheet embodiments may have a thickness greater than or equal to 30 μm and less than or equal to 6 mm, greater than or equal to 30 μm and less than or equal to 5 mm, greater than or equal to 30 μm and less than or equal to 4 mm, greater than or equal to 30 μm and less than or equal to 3 mm, greater than or equal to 30 μm and less than or equal to 2 mm, greater than or equal to 50 μm and less than or equal to 6 mm, greater than or equal to 50 μm and less than or equal to 5 mm, greater than or equal to 50 μm and less than or equal to 4 mm, greater than or equal to 50 μm and less than or equal to 3 mm, greater than or equal to 50 μm and less than or equal to 2 mm, greater than or equal to 100 μm and less than or equal to 6 mm, greater than or equal to 100 μm and less than or equal to 5 mm, greater than or equal to 100 μm and less than or equal to 4 mm, greater than or equal to 100 μm and less than or equal to 3 mm, greater than or equal to 100 μm and less than or equal to 2 mm, greater than or equal to 250 μm and less than or equal to 6 mm, greater than or equal to 250 μm and less than or equal to 5 mm, greater than or equal to 250 μm and less than or equal to 4 mm, greater than or equal to 250 μm and less than or equal to 3 mm, greater than or equal to 250 μm and less than or equal to 2 mm, greater than or equal to 500 μm and less than or equal to 6 mm, greater than or equal to 500 μm and less than or equal to 5 mm, greater than or equal to 500 μm and less than or equal to 4 mm, greater than or equal to 500 μm and less than or equal to 3 mm, greater than or equal to 500 μm and less than or equal to 2 mm, greater than or equal to 750 μm and less than or equal to 6 mm, greater than or equal to 750 μm and less than or equal to 5 mm, greater than or equal to 750 μm and less than or equal to 4 mm, greater than or equal to 750 μm and less than or equal to 3 mm, greater than or equal to 750 μm and less than or equal to 2 mm, greater than or equal to 1 mm and less than or equal to 6 mm, greater than or equal to 1 mm and less than or equal to 5 mm, greater than or equal to 1 mm and less than or equal to 4 mm, greater than or equal to 1 mm and less than or equal to 3 mm, or even greater than or equal to 1 mm and less than or equal to 2 mm, or any and all sub-ranges formed from any of these endpoints.

In embodiments, the multi-phase glasses described herein are ion exchangeable to facilitate strengthening the multi-phase glass. In typical ion exchange processes, smaller metal ions in the multi-phase glass are replaced or “exchanged” with larger metal ions of the same valence within a layer that is close to the outer surface of the multi-phase glass. The replacement of smaller ions with larger ions creates a compressive stress within the layer of the multi-phase glass. In embodiments, the metal ions are monovalent metal ions (e.g., Li⁺, Na⁺, K⁺, and the like), and ion exchange is accomplished by immersing the multi-phase glass in a bath comprising at least one molten salt of the larger metal ion that is to replace the smaller metal ion in the multi-phase glass. Alternatively, other monovalent ions such as Ag⁺, Tl⁺, Cu⁺, and the like may be exchanged for monovalent ions. The ion exchange process or processes that are used to strengthen the multi-phase glass may include, but are not limited to, immersion in a single bath or multiple baths of like or different compositions with washing and/or annealing steps between immersions.

Upon exposure to the multi-phase glass, the ion exchange solution (e.g., KNO₃ and/or NaNO₃ molten salt bath) may, according to embodiments, be at a temperature greater than or equal to 350° C. and less than or equal to 550° C., greater than or equal to 350° C. and less than or equal to 525° C., greater than or equal to 350° C. and less than or equal to 500° C., greater than or equal to 350° C. and less than or equal to 475° C., greater than or equal to 375° C. and less than or equal to 550° C., greater than or equal to 375° C. and less than or equal to 525° C., greater than or equal to 375° C. and less than or equal to 500° C., greater than or equal to 375° C. and less than or equal to 475° C., greater than or equal to 400° C. and less than or equal to 550° C., greater than or equal to 400° C. and less than or equal to 525° C., greater than or equal to 400° C. and less than or equal to 500° C., or even greater than or equal to 400° C. and less than or equal to 475° C., or any and all sub-ranges formed from any of these endpoints. In embodiments, the multi-phase glass may be exposed to the ion exchange solution for a duration greater than or equal to 2 hours and less than or equal to 24 hours, greater than or equal to 2 hours and less than or equal to 18 hours, greater than or equal to 2 hours and less than or equal to 12 hours, greater than or equal to 4 hours and less than or equal to 24 hours, greater than or equal to 4 hours and less than or equal to 18 hours, greater than or equal to 4 hours and less than or equal to 12 hours, greater than or equal to 6 hours and less than or equal to 24 hours, greater than or equal to 6 hours and less than or equal to 18 hours, or even greater than or equal to 6 hours and less than or equal to 12 hours, or any and all sub-ranges formed from any of these endpoints.

In embodiments, the multi-phase glass may have a peak surface compressive stress, after ion exchange strengthening, greater than or equal to 450 MPa. In embodiments, the multi-phase glass may have a peak surface compressive stress, after ion exchange strengthening, greater than or equal to 450 MPa, greater than or equal to 500 MPa, greater than or equal to 550 MPa, greater than or equal to 600 MPa, or even greater than or equal to 650 MPa. In embodiments, the multi-phase glass may have a peak surface compressive stress, after ion exchange strengthening, less than or equal to 950 MPa or even less than or equal to 900 MPa. In embodiments, the multi-phase glass may have a peak surface compressive stress, after ion exchange strengthening, greater than or equal to 450 MPa and less than or equal to 950 MPa, greater than or equal to 450 MPa and less than or equal to 900 MPa, greater than or equal to 500 MPa and less than or equal to 950 MPa, greater than or equal to 500 MPa and less than or equal to 900 MPa, greater than or equal to 550 MPa and less than or equal to 950 MPa, greater than or equal to 550 MPa and less than or equal to 900 MPa, greater than or equal to 600 MPa and less than or equal to 950 MPa, greater than or equal to 600 MPa and less than or equal to 900 MPa, greater than or equal to 650 MPa and less than or equal to 950 MPa, or even greater than or equal to 650 MPa and less than or equal to 900 MPa, or any and all sub-ranges formed from any of these endpoints.

In embodiments, the multi-phase glass may have a depth of layer, after ion exchange strengthening, greater than or equal to 3 μm. In embodiments, the multi-phase glass may have a depth of layer, after ion exchange strengthening, greater than or equal to 3 μm, greater than or equal to 4 μm, greater than or equal to 5 μm, or even greater than or equal to 6 μm. In embodiments, the multi-phase glass may have a depth of layer, after ion exchange strengthening, less than or equal to 12 μm, less than or equal to 10 μm, or even less than or equal to 8 μm. In embodiments, the multi-phase glass may have a depth of layer, after ion exchange strengthening, greater than or equal to 3 μm and less than or equal to 12 μm, greater than or equal to 3 μm and less than or equal to 10 μm, greater than or equal to 3 μm and less than or equal to 8 μm, greater than or equal to 4 μm and less than or equal to 12 μm, greater than or equal to 4 μm and less than or equal to 10 μm, greater than or equal to 4 μm and less than or equal to 8 μm, greater than or equal to 5 μm and less than or equal to 12 μm, greater than or equal to 5 μm and less than or equal to 10 μm, greater than or equal to 5 μm and less than or equal to 8 μm, greater than or equal to 6 μm and less than or equal to 12 μm, greater than or equal to 6 μm and less than or equal to 10 μm, or even greater than or equal to 6 μm and less than or equal to 8 μm, or any and all sub-ranges formed from any of these endpoints.

In embodiments, the multi-phase glass may have a thickness t and depth of compression, after ion exchange strengthening, greater than or equal to 0.035t. In embodiments, the multi-phase glass may have a thickness t and depth of compression, after ion exchange strengthening, greater than or equal to 0.035t, greater than or equal to 0.05t, greater than or equal to 0.075t, greater than or equal to 0.1t, or even greater than or equal to 0.15t. In embodiments, the multi-phase glass may have a thickness t and depth of compression, after ion exchange strengthening, less than or equal to 0.3t or even less than or equal to 0.25t. In embodiments, the multi-phase glass may have a thickness t and depth of compression, after ion exchange strengthening, greater than or equal to 0.035t and less than or equal to 0.3t, greater than or equal to 0.035t and less than or equal to 0.25t. greater than or equal to 0.05t and less than or equal to 0.3t, greater than or equal to 0.05t and less than or equal to 0.25t, greater than or equal to 0.075t and less than or equal to 0.3t, greater than or equal to 0.075t and less than or equal to 0.25t, greater than or equal to 0.1t and less than or equal to 0.3t, greater than or equal to 0.1t and less than or equal to 0.25t, greater than or equal to 0.15t and less than or equal to 0.3t, or even greater than or equal to 0.15t and less than or equal to 0.25t, or any and all sub-ranges formed from any of these endpoints.

In embodiments, the multi-phase glass may have a maximum central tension, after ion exchange strengthening, greater than or equal to 50 MPa, as measured at an article thickness of 0.8 mm. In embodiments, the multi-phase glass may have a maximum central tension, after ion exchange strengthening, greater than or equal to 50 MPa, greater than or equal to 75 MPa, or even greater than or equal to 100 MPa, as measured at an article thickness of 0.8 mm. In embodiments, the multi-phase glass may have a maximum central tension, after ion exchange strengthening, less than or equal to 300 MPa, less than or equal to 250 MPa, or even less than or equal to 200 MPa, as measured at an article thickness of 0.8 mm. In embodiments, the multi-phase glass may have a maximum central tension, after ion exchange strengthening, greater than or equal to 50 MPa and less than or equal to 300 MPa, greater than or equal to 50 MPa and less than or equal to 250 MPa, greater than or equal to 50 MPa and less than or equal to 200 MPa, greater than or equal to 75 MPa and less than or equal to 300 MPa, greater than or equal to 75 MPa and less than or equal to 250 MPa, greater than or equal to 75 MPa and less than or equal to 200 MPa, greater than or equal to 100 MPa and less than or equal to 300 MPa, greater than or equal to 100 MPa and less than or equal to 250 MPa, or even greater than or equal to 100 MPa and less than or equal to 200 MPa, or any and all sub-ranges formed from any of these endpoints, as measured at an article thickness of 0.8 mm.

In embodiments, the multi-phase glass may have a stored strain energy, after ion exchange strengthening, greater than or equal to 10 J/m², greater than or equal to 15 J/m², greater than or equal to 20 J/m², greater than or equal to 25 J/m², or even greater than or equal to 30 J/m². In embodiments, a stored strain energy of the multi-phase glass is greater than or equal to 32 J/m² and the multi-phase glass is non-frangible.

The multi-phase glasses described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, watches, personal computers, ultrabooks, televisions, and cameras), an architectural glass, and/or an automotive glass may comprise a multi-phase glass as described herein.

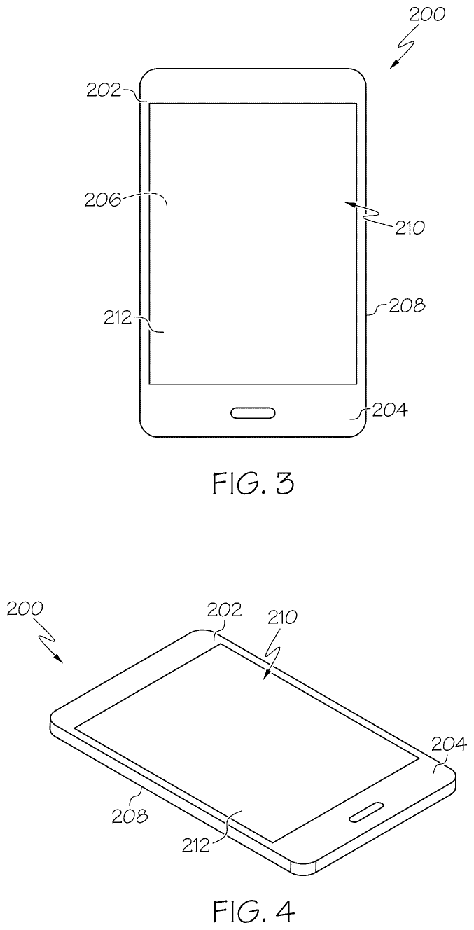

An exemplary electronic device incorporating any of the multi-phase glasses disclosed herein is shown in FIGS. 3 and 4. Specifically, FIGS. 3 and 4 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the multi-phase glasses disclosed herein.

### Examples

In order that various embodiments be more readily understood, reference is made to the following examples, which are intended to illustrate various embodiments of the glass compositions described herein.

Table 1 shows the analyzed example glass compositions of resulting multi-phase glasses G1-G28 (in terms of mol %) and the respective properties thereof. To form multi-phase glasses G1-G28, glass compositions were heated to a glass melting temperature of 1650° C., maintained at the glass melting temperature for 12 hours, and then cooled to room temperature.

TABLE 1

| Example | G1 | G2 | G3 | G4 | G5 | G6 |
|---|---|---|---|---|---|---|
| SiO₂ | 64.74 | 62.15 | 61.43 | 64.91 | 61.27 | 63.60 |
| Al₂O₃ | 7.18 | 6.86 | 9.88 | 7.24 | 11.85 | 7.05 |
| B₂O₃ | 12.40 | 11.44 | 8.96 | 9.61 | 7.07 | 12.24 |
| Li₂O | 6.70 | 8.79 | 9.05 | 8.12 | 9.12 | 8.17 |
| Na₂O | 0.05 | 1.93 | 1.98 | 0.91 | 1.97 | 0.04 |
| K₂O | 0.02 | 0.21 | 0.23 | 0.23 | 0.23 | 0.02 |
| MgO | 5.00 | 4.82 | 4.77 | 5.06 | 4.77 | 4.95 |
| SrO | — | — | — | — | — | — |
| CaO | 3.80 | 3.69 | 3.60 | 3.80 | 3.60 | 3.81 |
| BaO | — | — | — | — | — | — |
| ZrO₂ | — | — | — | — | — | — |
| Y₂O₃ | — | — | — | — | — | — |
| TiO₂ | — | — | — | — | — | — |
| P₂O₅ | — | — | — | — | — | — |
| SnO₂ | 0.10 | 0.11 | 0.11 | 0.11 | 0.11 | 0.11 |
| RO | 8.80 | 8.51 | 8.37 | 8.86 | 8.38 | 8.76 |
| R₂O | 6.77 | 10.93 | 11.26 | 9.27 | 11.32 | 8.23 |
| B₂O₃ + RO | 21.20 | 19.95 | 17.33 | 18.47 | 15.45 | 21.00 |
| R₂O/Al₂O₃ | 0.94 | 1.59 | 1.14 | 1.28 | 0.96 | 1.17 |
| R₂O − Al₂O₃ | −0.41 | 4.06 | 1.38 | 2.03 | −0.53 | 1.18 |
| B₂O₃/Al₂O₃ | 1.73 | 1.67 | 0.91 | 1.33 | 0.60 | 1.74 |
| (R₂O—Al₂O₃) − | −12.81 | −7.37 | −7.58 | −7.59 | −7.60 | −11.07 |
| B₂O₃ | | | | | | |
| RO − B₂O₃ | −3.60 | −2.92 | −0.59 | −0.75 | 1.31 | −3.48 |
| (RO—Al₂O₃) − | −4.01 | 1.14 | 0.79 | 1.28 | 0.78 | −2.30 |
| B₂O₃ | | | | | | |
| Li₂O/R₂O | 0.99 | 0.80 | 0.80 | 0.88 | 0.81 | 0.99 |
| ZrO₂ + Y₂O₃ + | — | — | — | — | — | — |
| TiO₂ | | | | | | |
| Density (g/cm³) | 2.360 | 2.408 | 2.422 | 2.395 | 2.431 | 2.372 |
| Young's modulus | 77.2 | 82.4 | 82.2 | 81.2 | 82.5 | 79.4 |
| (GPa) | | | | | | |
| Shear modulus | 31.6 | 33.8 | 33.5 | 33.3 | 33.6 | 32.5 |
| (GPa) | | | | | | |
| Poisson's ratio | 0.217 | 0.219 | 0.226 | 0.218 | 0.228 | 0.219 |
| K_{Ic} (MPa · m^{1/2}) | 0.83 | 0.84 | 0.81 | 0.83 | 0.76 | 0.83 |
| SOC | 3.279 | 3.021 | 2.987 | 3.033 | 2.968 | 3.156 |
| (nm/MPa · mm) | | | | | | |
| Refractive index | 1.511 | 1.520 | 1.528 | 1.517 | 1.524 | 1.516 |
| Example | G7 | G8 | G9 | G10 | G11 | G12 |
| SiO₂ | 64.84 | 64.37 | 62.89 | 62.86 | 62.08 | 61.35 |
| Al₂O₃ | 8.23 | 9.10 | 10.72 | 11.56 | 10.43 | 8.61 |
| B₂O₃ | 9.47 | 8.91 | 9.61 | 7.09 | 7.57 | 9.70 |
| Li₂O | 8.33 | 9.47 | 8.56 | 11.29 | 10.15 | 8.57 |
| Na₂O | 0.08 | 0.08 | 0.10 | 0.10 | 0.10 | 0.08 |
| K₂O | 0.03 | 0.03 | 0.03 | 0.03 | 0.03 | 0.03 |
| MgO | 3.32 | 2.93 | 3.01 | 2.62 | 4.71 | 5.46 |
| SrO | 0.23 | 0.21 | 0.20 | 0.17 | 0.20 | 0.24 |
| CaO | 5.49 | 4.90 | 4.89 | 4.27 | 4.73 | 5.96 |
| BaO | — | — | — | — | — | — |
| ZrO₂ | — | — | — | — | — | — |
| Y₂O₃ | — | — | — | — | — | — |
| TiO₂ | — | — | — | — | — | — |
| P₂O₅ | — | — | — | — | — | — |
| SnO₂ | — | — | — | — | — | — |
| RO | 9.03 | 8.05 | 8.10 | 7.06 | 9.64 | 11.66 |
| R₂O | 8.43 | 9.58 | 8.69 | 11.43 | 10.27 | 8.68 |
| B₂O₃ + RO | 18.50 | 16.96 | 17.71 | 14.15 | 17.21 | 21.36 |
| R₂O/Al₂O₃ | 1.03 | 1.05 | 0.81 | 0.99 | 0.98 | 1.01 |
| R₂O − Al₂O₃ | 0.21 | 0.48 | −2.03 | −0.13 | −0.16 | 0.07 |
| B₂O₃/Al₂O₃ | 1.15 | 0.98 | 0.90 | 0.61 | 0.73 | 1.13 |
| (R₂O—Al₂O₃) − | −9.26 | −8.43 | −11.64 | −7.22 | −7.73 | −9.64 |
| B₂O₃ | | | | | | |
| RO − B₂O₃ | −0.43 | −0.87 | −1.50 | −0.03 | 2.06 | 1.96 |
| (RO—Al₂O₃) − | −0.22 | −0.38 | −3.54 | −0.16 | 1.90 | 2.02 |
| B₂O₃ | | | | | | |
| Li₂O/R₂O | 0.99 | 0.99 | 0.99 | 0.99 | 0.99 | 0.99 |
| ZrO₂ + Y₂O₃ + | — | — | — | — | — | — |
| TiO₂ | | | | | | |
| Density (g/cm³) | 2.419 | 2.421 | 2.414 | 2.414 | 2.434 | 2.437 |
| Young's modulus | 83.1 | 82.4 | 82.1 | 82.4 | 84.0 | 84.3 |
| (GPa) | | | | | | |
| Shear modulus | 33.8 | 33.6 | 33.6 | 33.6 | 34.1 | 34.3 |
| (GPa) | | | | | | |
| Poisson's ratio | 0.230 | 0.227 | 0.224 | 0.228 | 0.230 | 0.229 |
| K_{Ic} (MPa · m^{1/2}) | — | — | — | — | — | — |
| SOC | 2.983 | 2.844 | 2.957 | 2.938 | 2.872 | 2.942 |
| (nm/MPa · mm) | | | | | | |
| Refractive index | 1.522 | — | 1.522 | 1.527 | 1.527 | 1.531 |
| Example | G13 | G14 | G15 | G16 | G17 | G18 |
| SiO₂ | 62.00 | 61.65 | 61.88 | 65.01 | 64.32 | 64.38 |
| Al₂O₃ | 9.97 | 10.00 | 9.97 | 7.37 | 7.45 | 7.45 |
| B₂O₃ | 8.61 | 8.84 | 8.68 | 9.49 | 9.71 | 9.65 |
| Li₂O | 8.96 | 9.07 | 9.06 | 8.09 | 8.38 | 8.33 |
| Na₂O | 1.91 | 1.91 | 1.88 | 0.86 | 0.86 | 0.87 |
| K₂O | 0.21 | 0.21 | 0.21 | 0.21 | 0.22 | 0.22 |
| MgO | 6.58 | 8.25 | 3.76 | 3.03 | 7.17 | 6.17 |
| SrO | — | — | — | — | — | — |
| CaO | 1.64 | 0.06 | 4.55 | 5.92 | 1.89 | 2.92 |
| BaO | — | — | — | — | — | — |
| ZrO₂ | — | — | — | — | — | — |
| Y₂O₃ | — | — | — | — | — | — |
| TiO₂ | — | — | — | — | — | — |
| P₂O₅ | — | — | — | — | — | — |
| SnO₂ | 0.11 | — | — | 0.01 | — | — |
| RO | 8.22 | 8.31 | 8.31 | 8.96 | 9.07 | 9.09 |
| R₂O | 11.08 | 11.19 | 11.15 | 9.16 | 9.45 | 9.42 |
| B₂O₃ + RO | 16.83 | 17.15 | 16.99 | 18.45 | 18.78 | 18.74 |
| R₂O/Al₂O₃ | 1.11 | 1.12 | 1.12 | 1.24 | 1.27 | 1.26 |
| R₂O − Al₂O₃ | 1.11 | 1.19 | 1.19 | 1.79 | 2.00 | 1.9 |
| B₂O₃/Al₂O₃ | 0.86 | 0.88 | 0.87 | 1.29 | 1.30 | 1.30 |
| (R₂O—Al₂O₃) − | −7.50 | −7.65 | −7.49 | −7.70 | −7.70 | −7.69 |
| B₂O₃ | | | | | | |
| RO − B₂O₃ | −0.39 | −0.53 | −0.37 | −0.53 | −0.64 | −0.56 |
| (RO—Al₂O₃) − | 0.72 | 0.66 | 0.82 | 1.26 | 1.37 | 1.40 |
| B₂O₃ | | | | | | |
| Li₂O/R₂O | 0.81 | 0.81 | 0.81 | 0.88 | 0.89 | 0.88 |
| ZrO₂ + Y₂O₃ + | — | — | — | — | — | — |
| TiO₂ | | | | | | |
| Density (g/cm³) | 2.399 | 2.384 | 2.419 | 2.402 | 2.378 | 2.386 |
| Young's modulus | 81.2 | 80.5 | 82.1 | 82.4 | 80.5 | 80.6 |
| (GPa) | | | | | | |
| Shear modulus | 33.2 | 32.9 | 33.4 | 33.9 | 33.1 | 33.4 |
| (GPa) | | | | | | |
| Poisson's ratio | 0.223 | 0.224 | 0.227 | 0.218 | 0.217 | 0.216 |
| K_{Ic} (MPa · m^{1/2}) | — | — | — | — | — | — |
| SOC | 2.987 | 3.048 | 2.959 | 2.982 | 3.040 | 3.010 |
| (nm/MPa · mm) | | | | | | |
| Refractive index | — | — | — | — | — | — |
| Example | G19 | G20 | G21 | G22 | G23 | G24 |
| SiO₂ | 59.93 | 58.76 | 59.78 | 58.13 | 60.14 | 56.02 |
| Al₂O₃ | 9.86 | 9.80 | 9.91 | 9.92 | 9.85 | 9.87 |
| B₂O₃ | 8.90 | 8.78 | 8.48 | 8.23 | 8.28 | 8.61 |
| Li₂O | 9.07 | 9.09 | 9.18 | 9.10 | 9.07 | 9.33 |
| Na₂O | 1.96 | 1.95 | 1.86 | 1.85 | 1.83 | 1.82 |
| K₂O | 0.23 | 0.23 | 0.2 | 0.20 | 0.20 | 0.20 |
| MgO | 4.73 | 4.67 | 4.91 | 4.86 | 4.76 | 5.76 |
| SrO | — | — | — | — | — | — |
| CaO | 3.62 | 3.59 | 3.60 | 3.61 | 3.60 | 3.87 |
| BaO | — | — | — | — | — | — |
| ZrO₂ | 1.60 | 3.03 | — | — | 0.14 | 0.19 |
| Y₂O₃ | — | — | — | — | 1.99 | 4.19 |
| TiO₂ | — | — | 1.97 | 3.97 | 0.01 | 0.01 |
| P₂O₅ | — | — | — | — | — | — |
| SnO₂ | 0.11 | 0.10 | 0.11 | 0.12 | 0.12 | 0.13 |
| RO | 8.35 | 8.26 | 8.51 | 8.47 | 8.36 | 9.63 |
| R₂O | 11.26 | 11.27 | 11.24 | 11.15 | 11.10 | 11.35 |
| B₂O₃ + RO | 17.25 | 17.04 | 16.99 | 16.70 | 16.64 | 18.24 |
| R₂O/Al₂O₃ | 1.14 | 1.15 | 1.13 | 1.12 | 1.13 | 1.15 |
| R₂O − Al₂O₃ | 1.40 | 1.47 | 1.34 | 1.23 | 1.25 | 1.48 |
| B₂O₃/Al₂O₃ | 0.90 | 0.90 | 0.86 | 0.83 | 0.84 | 0.87 |
| (R₂O—Al₂O₃) − | −7.50 | −7.32 | −7.14 | −7.00 | −7.03 | −7.13 |
| B₂O₃ | | | | | | |
| RO − B₂O₃ | 1.04 | 2.51 | 0.04 | 0.24 | 0.22 | 1.20 |
| (RO—Al₂O₃) − | 2.44 | 3.97 | 1.37 | 1.47 | 1.47 | 2.68 |
| B₂O₃ | | | | | | |
| Li₂O/R₂O | 0.81 | 0.81 | 0.82 | 0.82 | 0.82 | 0.82 |
| ZrO₂ + Y₂O₃ + | 1.60 | 3.03 | 1.97 | 3.97 | 2.14 | 4.38 |
| TiO₂ | | | | | | |
| Density (g/cm³) | — | — | — | — | — | — |
| Young's modulus | 86.3 | 84.7 | 83.2 | 84.1 | 85.6 | 89.8 |
| (GPa) | | | | | | |
| Shear modulus | 35.1 | 34.4 | 33.9 | 34.2 | 34.7 | 36.3 |
| (GPa) | | | | | | |
| Poisson's ratio | 0.231 | 0.232 | 0.229 | 0.229 | 0.233 | 0.236 |
| K_{Ic} (MPa · m^{1/2}) | 0.79 | 0.80 | — | — | — | — |
| SOC | 3.031 | 3.072 | 2.984 | 3.033 | 2.819 | 2.732 |
| (nm/MPa · mm) | | | | | | |
| Refractive index | 1.532 | 1.541 | — | — | — | — |

| Example | G25 | G26 | G27 | G28 |
|---|---|---|---|---|
| SiO₂ | 56.11 | 55.78 | 63.80 | 59.35 |
| Al₂O₃ | 9.77 | 10.09 | 6.96 | 9.80 |
| B₂O₃ | 8.40 | 8.21 | 10.37 | 8.35 |
| Li₂O | 9.16 | 9.20 | 8.27 | 8.91 |
| Na₂O | 1.85 | 1.93 | 1.79 | 1.85 |
| K₂O | 0.22 | 0.23 | 0.19 | 0.23 |
| MgO | 4.79 | 4.82 | 4.80 | 4.71 |
| SrO | — | — | 0.05 | 0.05 |
| CaO | 3.63 | 3.71 | 1.82 | 1.81 |
| BaO | | | 1.80 | 1.82 |
| ZrO₂ | 0.08 | 5.89 | 0 | 2.99 |
| Y₂O₃ | 5.87 | 0.00 | 0 | 0.00 |
| TiO₂ | 0.01 | 0.01 | 0.01 | 0.01 |
| P₂O₅ | — | — | 0.02 | 0.02 |
| SnO₂ | 0.12 | 0.12 | 0.12 | 0.11 |
| RO | 8.42 | 8.54 | 8.48 | 8.38 |
| R₂O | 11.23 | 11.36 | 10.25 | 10.99 |
| B₂O₃ + RO | 16.82 | 16.75 | 18.85 | 16.73 |
| R₂O/Al₂O₃ | 1.15 | 1.13 | 1.47 | 1.12 |
| R₂O − Al₂O₃ | 1.46 | 1.26 | 3.29 | 1.19 |
| B₂O₃/Al₂O₃ | 0.86 | 0.81 | 1.49 | 0.85 |
| (R₂O—Al₂O₃) − | −6.94 | −6.94 | −7.08 | −7.15 |
| B₂O₃ | | | | |
| RO − B₂O₃ | 0.09 | 6.22 | −1.89 | 0.04 |
| (RO—Al₂O₃) − | 1.55 | 7.48 | −8.85 | −9.76 |
| B₂O₃ | | | | |
| Li₂O/R₂O | 0.82 | 0.81 | 0.81 | 0.81 |
| ZrO₂ + Y₂O₃ + | 5.95 | 5.90 | 0.01 | 2.99 |
| TiO₂ | | | | |
| Density (g/cm³) | — | — | — | — |
| Young's modulus | 93.2 | 88.9 | 81.3 | 83.7 |
| (GPa) | | | | |
| Shear modulus | 37.6 | 35.9 | 33.2 | 34.1 |
| (GPa) | | | | |
| Poisson's ratio | 0.242 | 0.240 | 0.223 | 0.23 |
| K_{Ic} (MPa · m^{1/2}) | — | — | 0.90 ± | 0.87 ± |
| | | | 0.022 | 0.013 |
| SOC | 2.574 | 3.046 | 2.961 | 3.021 |
| (nm/MPa · mm) | | | | |
| Refractive index | — | — | — | — |

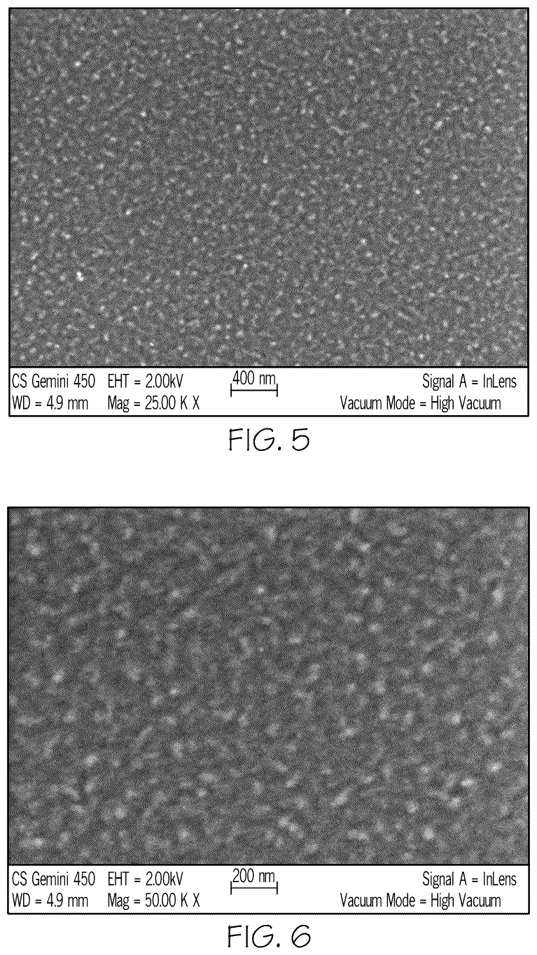

Referring now to FIGS. 5 and 6, multi-phase glass G19 included separated glass phases as shown in the images. As exemplified in FIGS. 5 and 6, heating a glass composition as described herein spontaneously phase separates the glass composition and results in a multi-phase glass.

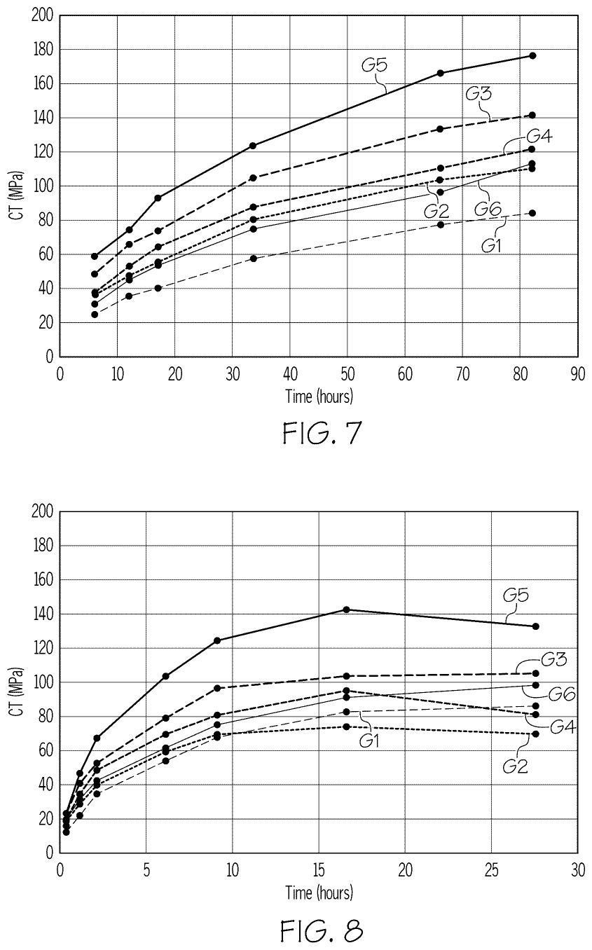

Referring now to FIG. 7, multi-phase glasses G1-G6 having a thickness of 0.8 mm were ion exchanged in a 100% NaNO₃ molten salt bath at 390° C. for 4 hours, 12 hours, 16 hours, 32 hours, 66 hours, and 82 hours, respectively. SCALP was used to measure the stress profile with central tension values reported as a function of ion exchange time in the figure.

Referring now to FIG. 8, multi-phase glasses G1-G6 having a thickness of 0.8 mm were ion exchanged in a 100% NaNO₃ molten salt bath at 460° C. for 0.5 hour, 1 hour, 2 hours, 6 hours, 9 hours, 17 hours, and 27.5 hours, respectively. Diffusivity was faster at the higher ion exchange temperature of 460° C. as compared to 390° C. ion exchange temperature. Additionally, the central tension values achieved at the 460° C. ion exchange temperature were lower than those achieved at the 390° C. ion exchange temperature, indicative of stress relaxation of the multi-phase glasses at the 460° C. ion exchange temperature. Furthermore, the maximum central values produced by the 460° C. ion exchange temperature were less than 140 MPa. As exemplified by FIGS. 7 and 8, the multi-phase glasses formed from the glass compositions described herein may be ion exchanged to achieve a desired maximum central tension.

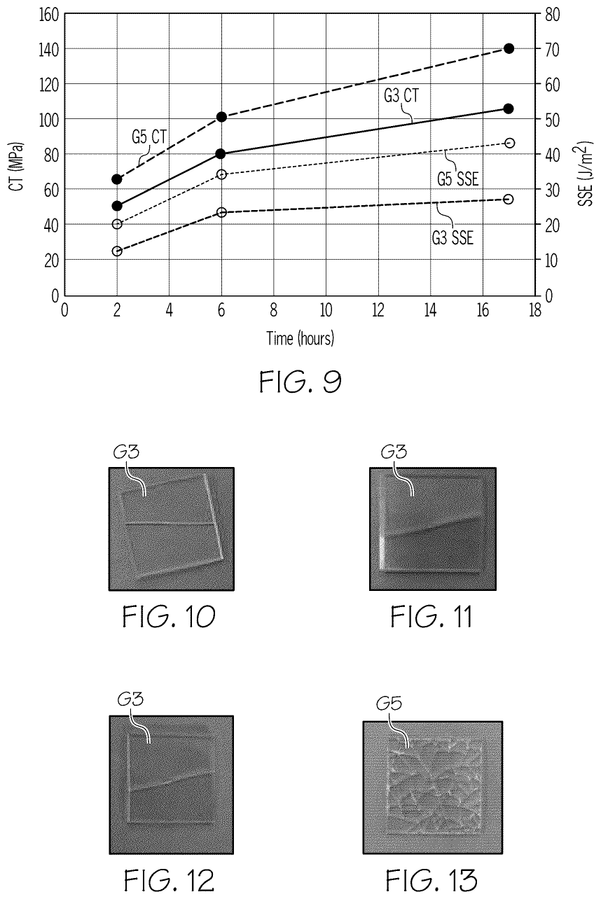

Referring now to FIG. 9, the resulting central tension and stored strain energy of multi-phase glasses G3 and G5 having a thickness of 0.8 mm after being ion exchanged in a 40% NaNO₃/60% KNO₃ molten salt bath at 460° C. for 2 hours, 6 hours, and 17 hours, respectively. Referring now to FIGS. 10-12, multi-phase glass G3, having a thickness of 0.8 mm and being ion exchanged in a 40% NaNO₃/60% KNO₃ molten salt bath at 460° C. for 2 hours, 6 hours, and 17 hours, respectively, was subjected to a frangibility test to assess the material fracture pattern. As shown in FIGS. 10-12, the multi-phase glass G3 fractured into 2 parts at a stored strain energy (SSE) of about 30 J/m². Referring now to FIG. 13, multi-phase glass G5 having a thickness of 0.8 mm and ion exchanged in a 40% NaNO₃/60% KNO₃ molten salt bath at 460° C. for 6 hours, was subjected to the same impact test. As shown in FIG. 11, multi-phase glass G5 exhibited bifurcation of the cracks at a SSE of about 35 J/m². As exemplified by FIGS. 9-13, stored strain energy (SSE) values of greater than 20 J/m² and less than 30 J/m² were achieved without exhibiting bifurcated fracture patterns.

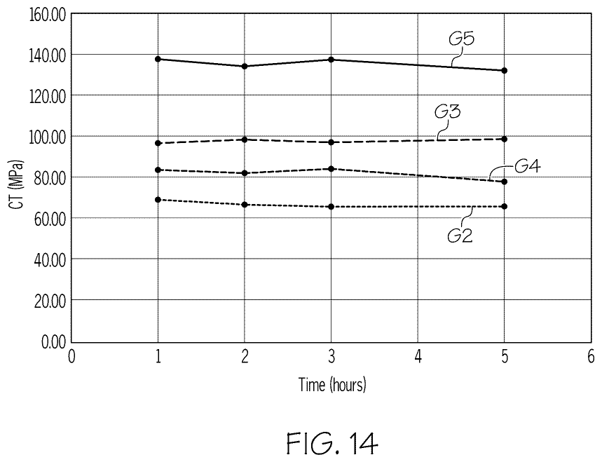

Referring now to FIG. 14, multi-phase glasses G2-G5 having a thickness of 0.8 mm were first ion exchanged in a 100% NaNO₃ molten salt bath at 460° C. for 10 hours and then ion exchanged in a 5% NaNO₃/95% KNO₃ molten salt bath at 460° C. for 5 hours. As shown in FIG. 14, the maximum central tension changed minimally as a result of the second ion exchange bath. Table 3 shows the peak surface compressive stress and depth of layer values achieved after the two baths.

TABLE 3

| Example | G2 | G3 | G4 | G5 |
|---|---|---|---|---|
| CS (MPa) | 670 | 495 | 600 | 503 |
| DOL (μm) | 6.5 | 7.5 | 7.5 | 7.5 |

Referring now to Table 4, multi-phase glasses G3 and G5 having a thickness of 0.8 mm were first ion exchanged in a 100% NaNO₃ molten salt bath at 430° C. for 20 hours and then ion exchanged in a 100% KNO₃ molten salt bath at 460° C. for 5 hours. As shown in Table 4, the multi-phase glasses formed from the glass compositions described herein may be subjected to certain ion exchange conditions to achieve a desired stress profile (i.e., peak surface compressive stress, depth of layer, maximum central tension, and depth of compression).

TABLE 4

| Example | G3 | | G5 | |
|---|---|---|---|---|
| Ion exchange | 100% NaNO₃ at | 100% KNO₃ at | 100% NaNO₃ at | 100% KNO₃ at |
| conditions | 430° C. for 20 hrs. | 460° C. for 3 hrs | 430° C. for 20 hrs. | 460° C. for 3 hrs |
| CS (MPa) | — | 791 | — | 874 |
| DOL (μm) | — | 6.34 | — | 6.34 |
| CT (MPa) | 155 | 109 | 174 | 129 |
| DOC (μm) | >100 | >100 | >100 | >100 |

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass composition comprising:
greater than or equal to 45 mol % and less than or equal to 70 mol % SiO₂;
greater than or equal to 5 mol % and less than or equal to 15 mol % Al₂O₃;
greater than or equal to 5 mol % and less than or equal to 15 mol % B₂O₃;
greater than or equal to 5.5 mol % and less than or equal to 15 mol % Li₂O; and
greater than or equal to 0.5 mol % and less than or equal to 12 mol % MgO, wherein
RO is greater than or equal 5.5 mol % and less than or equal to 14 mol %, wherein RO is the sum of MgO, CaO, BaO, and SrO,
the glass composition is free of at least one of La₂O₃ and Yb₂O₃, and
the glass composition is phase separable.

2. The glass composition of claim 1, wherein the glass composition comprises greater than or equal to 5.5 mol % and less than or equal to 14 mol % B₂O₃.

3. The glass composition of claim 1, wherein RO is greater than or equal to 6 mol % and less than or equal to 13 mol % RO.

4. The glass composition of claim 1, wherein B₂O₃+RO is greater than or equal to 10.5 mol % and less than or equal to 29 mol %.

5. The glass composition of claim 1, wherein the glass composition comprises greater than or equal to 1 mol % and less than or equal to 10 mol % MgO.

6. The glass composition of claim 1 wherein the glass composition comprises greater than or equal to 6 mol % and less than or equal to 14 mol % Li₂O.

7. The glass composition of claim 1, wherein the glass composition comprises greater than 0 mol % and less than or equal to 3 mol % Na₂O.

8. The glass composition of claim 1 wherein the glass composition comprises greater than 0 mol % and less than or equal to 2 mol % K₂O.

9. The glass composition of claim 1, wherein the glass composition comprises greater than 0 mol % and less than or equal to 10 mol % CaO.

10. The glass composition of claim 1, wherein the glass composition comprises greater than 0 mol % and less than or equal to 5 mol % BaO.

11. The glass composition of claim 1, wherein the glass composition comprises greater than 0 mol % and less than or equal to 2 mol % SrO.

12. The glass composition of claim 1, wherein ZrO₂+Y₂O₃+TiO₂ is greater than 0 mol % and less than or equal to 10 mol %.

13. A multi-phase glass comprising:
greater than or equal to 45 mol % and less than or equal to 70 mol % SiO₂;
greater than or equal to 5 mol % and less than or equal to 15 mol % Al₂O₃;
greater than or equal to 5 mol % and less than or equal to 15 mol % B₂O₃;
greater than or equal to 5.5 mol % and less than or equal to 15 mol % Li₂O; and
greater than or equal to 0.5 mol % and less than or equal to 12 mol % MgO, wherein
RO is greater than or equal 5.5 mol % and less than or equal to 14 mol %, wherein RO is the sum of MgO, CaO, BaO, and SrO,
the multi-phase glass is free of at least one of La₂O₃ and Yb₂O₃; and
the multi-phase glass comprises at least two phases.

14. The multi-phase glass of claim 13, an average transmittance of the multi-phase glass is greater than or equal to 88% over the wavelength range of 400 nm to 800 nm, as measured at an article thickness of 0.8 mm.

15. The multi-phase glass of claim 13, wherein the multi-phase glass comprises a Young's modulus greater than or equal to 70 GPa.

16. The multi-phase glass of claim 13, wherein the multi-phase glass comprises a K_{IC} fracture toughness greater than or equal to 0.70 MPa·m^{1/2}, as measured by a chevron notch short bar method.

17. A method of forming a multi-phase glass, the method comprising:
heating a glass composition, the glass composition comprising:
greater than or equal to 45 mol % and less than or equal to 70 mol % SiO₂;
greater than or equal to 5 mol % and less than or equal to 15 mol % Al₂O₃;
greater than or equal to 5 mol % and less than or equal to 15 mol % B₂O₃;
greater than or equal to 5.5 mol % and less than or equal to 15 mol % Li₂O; and
greater than or equal to 0.5 mol % and less than or equal to 12 mol % MgO, wherein
RO is greater than or equal 5.5 mol % and less than or equal to 14 mol %, wherein RO is the sum of MgO, CaO, BaO, and SrO, and
the glass composition is free of at least one of La₂O₃ and Yb₂O₃; and
cooling the glass composition to form the multi-phase.

18. The method of claim 17, wherein during the cooling step, the glass composition undergoes spinodal decomposition.

19. The method of claim 17, further comprising strengthening the multi-phase glass in an ion exchange bath at a temperature greater than or equal to 350° C. to less than or equal to 550° C. for a time period greater than or equal to 2 hours to less than or equal to 24 hours to form an ion exchanged multi-phase glass.

20. The method of claim 19, wherein the ion exchanged multiphase glass has a thickness t, a peak surface compressive stress greater than or equal to 450 MPa, a depth of layer greater than or equal to 3 μm, a depth of compression greater than or equal to 0.035t, and a maximum central tension greater than or equal to 50 MPa, as measured at an article thickness of 0.8 mm.
